(19) United States
(12) Patent Application Publication
(10) Pub. No.: US 2022/0286309 A1
(43) Pub. Date: Sep. 8, 2022

(54) EVENT MANAGEMENT SYSTEM, EVENT MANAGEMENT APPARATUS, AND EVENT MANAGEMENT METHOD

(71) Applicant: Takahiro KAMEKURA, Tokyo (JP)

(72) Inventor: Takahiro KAMEKURA, Tokyo (JP)

(21) Appl. No.: 17/679,119

(22) Filed: Feb. 24, 2022

(30) Foreign Application Priority Data
Mar. 8, 2021 (JP) 2021-036132

(51) Int. Cl. H04L 12/18; H04L 67/55

(52) U.S. Cl. CPC H04L 12/1818; H04L 67/26; H04L 12/1822

(57) ABSTRACT

An event management system includes multiple communication terminals used in an event, and an event management apparatus including first circuitry. The first circuitry of the event management apparatus receives an event start request that requests start of the event, the event start request being transmitted by one communication terminal among the multiple communication terminals. In response to the received event start request, the first circuitry of the event management apparatus transmits an event participation request that requests participation in the event to another communication terminal among the multiple communication terminals, the another communication terminal being associated with the event and associated with a participant who participates in the event using the one communication terminal.

### CROSS-REFERENCE TO RELATED APPLICATION

This patent application is based on and claims priority pursuant to 35 U.S.C. § 119(a) to Japanese Patent Application No. 2021-036132, filed on Mar. 8, 2021, in the Japan Patent Office, the entire disclosure of which is hereby incorporated by reference herein.

### BACKGROUND

### Technical Field

Embodiments of the present disclosure relate to an event management system, an event management apparatus, and an event management method.

### Related Art

Systems are known that connect devices provided respectively at remote locations through a network, to conduct various types of events such as a remote conference.

Further, a system is known in which, for the purpose of reliably transmitting a conference start notification to an apparatus that can be used by a participant when starting a conference, a remote conference server performs a conference start notification process and transmits a conference start notification to a communication apparatus that can be used by a user who is a conference participant and another communication apparatus that can be used by another user.

### SUMMARY

An embodiment of the present disclosure includes an event management system including multiple communication terminals used in an event, and an event management apparatus including first circuitry. The first circuitry of the event management apparatus receives an event start request that requests start of the event, the event start request being transmitted by one communication terminal among the multiple communication terminals. In response to the received event start request, the first circuitry of the event management apparatus transmits an event participation request that requests participation in the event to another communication terminal among the multiple communication terminals, the another communication terminal being associated with the event and associated with a participant who participates in the event using the one communication terminal.

Another embodiment of the present disclosure includes an event management apparatus that manages one communication terminal among multiple communication terminals used in an event in association with the event. The event management apparatus includes circuitry. The circuitry receives an event start request that requests start of the event, the event start request being transmitted by the one communication terminal. In response to the received event start request, the circuitry transmits an event participation request that requests participation in the event to another communication terminal among the multiple communication terminals, the another communication terminal being associated with the event and associated with a participant who participates in the event using the one communication terminal.

Another embodiment of the present disclosure includes an event management method performed by an event management apparatus that manages one communication terminal among multiple communication terminals used in an event in association with the event. The method includes receiving an event start request that requests start of the event, the event start request being transmitted by the one communication terminal. The method includes, in response to receiving the event start request, transmitting an event participation request that requests participation in the event to another communication terminal among the multiple communication terminals, the another communication terminal being associated with the event and associated with a participant who participates in the event using the one communication terminal.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of an overall configuration of an event management system, according to an embodiment of the present disclosure;

FIG. 2 is a block diagram illustrating an example of a hardware configuration of a computer, according to an embodiment of the present disclosure;

FIG. 3 is a block diagram illustrating an example of a hardware configuration of a shared terminal, according to an embodiment of the present disclosure;

FIG. 4 is a block diagram illustrating an example of a functional configuration of the event management system, according to an embodiment of the present disclosure;

FIG. 5A is a conceptual diagram illustrating an example of a terminal management table, according to an embodiment of the present disclosure;

FIG. 5B is a conceptual diagram illustrating an example of a pair settings management table, according to an embodiment of the present disclosure;

FIG. 5C is a conceptual diagram illustrating an example of a shared terminal management table, according to an embodiment of the present disclosure;

FIG. 5D is a conceptual diagram illustrating an example of a participant management table, according to an embodiment of the present disclosure;

FIG. 5E is a conceptual diagram illustrating an example of a participating terminal management table, according to an embodiment of the present disclosure;

FIG. 5F is a conceptual diagram illustrating an example of an equipment management table, according to an embodiment of the present disclosure;

FIG. 6 is a sequence diagram illustrating an example of operation of login and participating in an event, according to an embodiment of the present disclosure;

FIG. 7 illustrates an example of a screen displayed when making a reservation for an online meeting, according to an embodiment of the present disclosure;

FIG. 8 is a sequence diagram illustrating an example of operation of starting a pairing setting, according to an embodiment of the present disclosure;

FIG. 9 is a sequence diagram illustrating an example of operation of configuring terminal pairing settings, according to an embodiment of the present disclosure;

FIG. 10 is a sequence diagram illustrating an example of operation of selecting a communication terminal for which the terminal paring is to be performed, according to an embodiment of the present disclosure;

FIG. 11 illustrates an example of a screen displayed when participating in an online meeting, according to an embodiment of the present disclosure;

FIG. 12 illustrates an example of a screen display of a dialog for selecting a terminal pairing setting, according to an embodiment of the present disclosure;

FIG. 13 illustrates an example of a screen display of a dialog for newly creating a terminal pairing, according to an embodiment of the present disclosure;

FIG. 14 illustrates an example of a screen display of a dialog for selecting a pair name and a communication terminal for which a terminal paring setting is to be configured, according to an embodiment of the present disclosure;

FIG. 15A illustrates an example of a screen display of a dialog for setting terminal pairing including a shared terminal, according to an embodiment of the present disclosure;

FIG. 15B illustrates an example of a screen display of another dialog for setting terminal pairing including a shared terminal, according to an embodiment of the present disclosure;

FIG. 16 is a sequence diagram illustrating an example of operation of starting an event, according to the first embodiment of the present disclosure;

FIG. 17 is a flowchart illustrating an example of operation of whether any paired terminal is present, according to the first embodiment of the present disclosure;

FIG. 18 is a sequence diagram illustrating an example of operation of participating in an event, according to the first embodiment of the present disclosure;

FIG. 19 illustrates an example of a screen of a dialog requesting another communication terminal to participate in an event, according to the first embodiment of the present disclosure;

FIG. 20 is a sequence diagram illustrating an example of operation of starting an event, according to the second embodiment of the present disclosure;

FIG. 21 is a flowchart illustrating an example of operation of whether any paired terminal is present, according to the second embodiment of the present disclosure;

FIG. 22 is a flowchart illustrating an example of operation of determining whether pair participation is to be performed, according to the second embodiment of the present disclosure;

FIG. 23 is a sequence diagram illustrating an example of operation of participating in an event, according to the second embodiment of the present disclosure;

FIG. 24 illustrates an example of a screen display of a pair participation confirmation dialog, according to the second embodiment of the present disclosure;

FIG. 25 is a sequence diagram illustrating an example of operation of starting an event, according to a variation of the second embodiment of the present disclosure;

FIG. 26 is a sequence diagram illustrating an example of operation of participating an event, according to a variation of the second embodiment of the present disclosure; and

FIG. 27 illustrates an example of a screen display on a shared terminal, according to the variation of the second embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to the drawings, embodiments of the present disclosure are described. In the description of the drawings, the same elements are denoted by the same reference numerals, and redundant descriptions thereof are omitted.

### First Embodiment

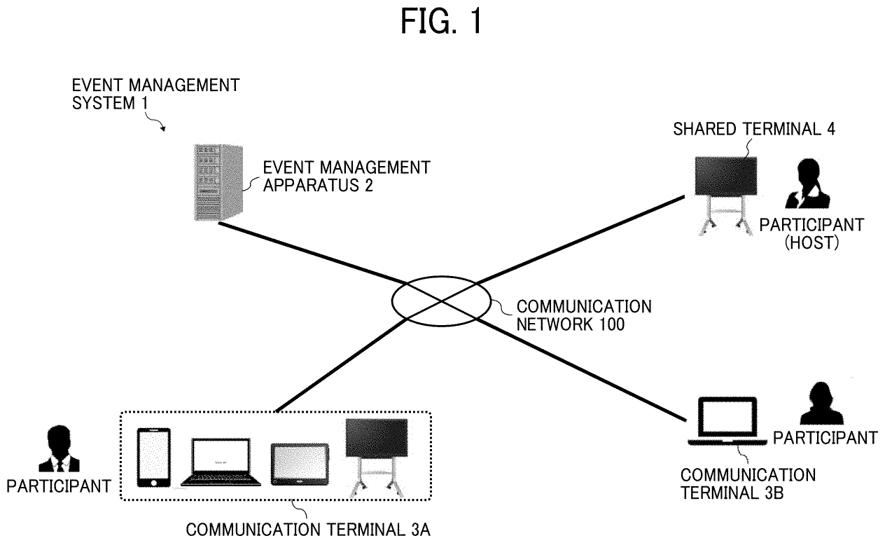

Referring to FIG. 1 to FIG. 21, a description is given of a first embodiment of the present disclosure.

Overview of Configuration of Event Management System:

FIG. 1 is a diagram illustrating an example of an overall configuration of an event management system 1. As illustrated in FIG. 1, the event management system 1 includes an event management apparatus 2, a communication terminal 3A, a communication terminal 3B, and a shared terminal 4. The event management apparatus 2, the communication terminal 3A, the communication terminal 3B, and the shared terminal 4 are connected to each other through a communication network 100. The communication network 100 includes the Internet, a mobile communication network, and a local area network (LAN), for example. In another example, the communication network 100 include, in addition to a wired communication, a network by a wireless communication in compliance with, for example, 3rd Generation (3G), 4th Generation (4G), 5th Generation (5G), Worldwide Interoperability for Microwave Access (WiMAX), and Long Term Evolution (LTE). In still another example, the event management system 1 includes a generally known reservation management system that manages reservations for events, schedules of users, etc.

Event Management Apparatus:

The event management apparatus 2 is implemented by an information processing apparatus (computer system) installed with a general-purpose operating system (OS) and having a server function. The event management apparatus 2 is communicable with the communication terminal 3A, the communication terminal 3B, and the shared terminal 4. The event management apparatus 2 exchanges various data (information) with the communication terminal 3A, the communication terminal 3B, and the shared terminal 4. In another example, the event management apparatus 2 may be implemented by a general-purpose personal computer (PC).

Communication Terminal:

The communication terminal 3A and the communication terminal 3B are each implemented by an information processing apparatus (computer system) installed with a general-purpose OS. In the following description, the communication terminal 3A and the communication terminal 3B may be collectively referred to as a “communication terminal 3”, unless they need to be distinguished from one to another. The communication terminal 3 is a communication terminal used by a participant who participates in an event. The communication terminal 3 communicates with the event management apparatus 2 and the shared terminal 4 through the communication network 100. In the present embodiment, the description is provided on the assumption that one participant uses multiple communication terminals 3A or multiple communication terminals 3B, such as a communication terminal 3A (1), a communication terminal 3A (2), . . . , or a communication terminals 3B (1), a communication terminal 3B (2), . . . . In another example, the communication terminal 3 is a communication terminal having a communication capability, such as a smartphone, a tablet terminal, a personal digital assistant (PDA), or a wearable PC of sunglasses type or wristwatch type, for example. In other words, one participant can use multiple communication terminals of different types in the same event, such as a PC as the communication terminal 3A (1) and a smartphone as the communication terminal 3A (2). In still another example, the communication terminal 3 may be a general-purpose PC. In other words, any terminal capable of executing software such as browser software may be used as the communication terminal 3.

Shared Terminal:

The shared terminal 4 is implemented by an information processing apparatus (computer system) installed with a general-purpose OS. The shared terminal 4 is a communication terminal that is installed or located in various resources and can be used by a participant who participates in an event. The shared terminal 4 communicates with the event management apparatus 2 and the communication terminal 3 through the communication network 100. The shared terminal 4 is an example of a communication terminal having a communication capability, such as an interactive whiteboard (IWB), a projector, and a videoconference system (unified communication system: UCS). In the following description, the IWB may be referred to as an “electronic whiteboard”.

Terms:

In the present embodiment, the term “event” refers to any event that is held at a predetermined date and time and a predetermined indoor or outdoor location or space, such as a conference, a meeting, entertainment, a lecture, an exhibition, or a concert. Further, in the present embodiment, the term “event” includes an activity that is customarily conducted at fixed date and time. In the present embodiment, a description is provided of an example in which an event is a meeting.

Further, in the present embodiment, the term “start” refers to, for example, starting an event. Examples of the start include causing a communication terminal to be used is an event to be in a ready state, and performing a login process to causing the communication terminal to be ready to communicate with other apparatuses in an event. Further, the term “participate” refers to, for example, being involved in an event. For example, the term “participate” includes that the communication terminal performs a login process to be ready to communicate with other apparatuses in an event.

The term “resource” refers to any resource owned, rented, or managed by a company, a group, an organization, or the like. The resource of a company, a group, an organization, or the like, includes for example, a meeting room (conference room) and a facility usable in the meeting room, a device, and a worker (reception group). In addition, the resource includes a free space having a free address, a desk, a chair, a place such as a booth, a company car, a bicycle, a parking lot, a bicycle parking lot, a teleconferencing system, and a printing service and mechanism. From among the resources, a resource that is difficult to be moved is referred to as a “facility”. In the description of the present embodiment, for the sake of explanatory convenience, the term “meeting room” is used as an example of the resource. In addition, examples of the resource include accommodation facilities such as hotels, various facility spaces such as rental offices, rental studios, and event venues, and various items such as electronic devices, rental lockers, rental cycles, and rental cars (sharing cars).

Hardware Configuration:

Hardware Configurations of Event Management Apparatus and Communication Terminal:

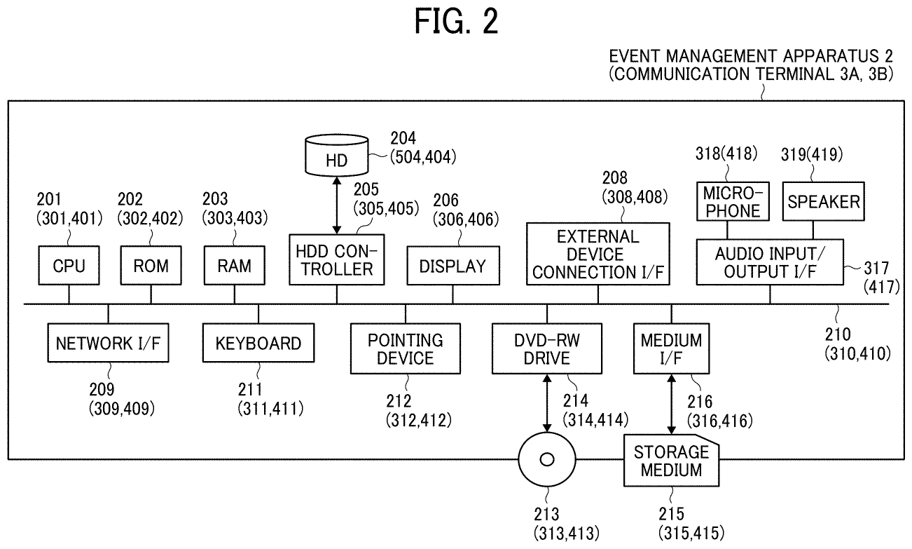

FIG. 2 is a block diagram illustrating an example of a hardware configuration of a computer. As illustrated in FIG. 2, the event management apparatus is implemented by one or more computers. Specifically, as illustrated in FIG. 2, the event management apparatus 2 includes hardware resources including a central processing unit (CPU) 201, a read only memory (ROM) 202, a random access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a digital versatile disk rewritable (DVD-RW) drive 214, a medium I/F 216, an audio input/output I/F 217, a microphone 218, and a speaker 219.

The CPU 201 controls overall operation of the event management apparatus 2. The ROM 202 stores a program to boot the CPU 201. The RAM 203 is used as a work area for the CPU 201. The HD 204 stores various data such as a control program. The HDD controller 205 controls reading or writing of various data from or to the HD 204 under control of the CPU 201. The display 206 is an example of a display device (display means) that displays various types of information such as a cursor, a menu, a window, characters, and an image. In one example, the display 206 is a touch panel display provided with an input device. The external device connection I/F 208 is an interface that connects the event management apparatus 2 to various external devices. Examples of the external devices include, but are not limited to, a universal serial bus (USB) memory and a USB device. The network I/F 209 is an interface that enables the event management apparatus 2 to perform data communication through the communication network 100. The bus line 210 is, for example, an address bus or a data bus, which electrically connects the hardware elements illustrated in FIG. 2 such as the CPU 201 with each other.

The keyboard 211 is an example of an input device (input means) including a plurality of keys for inputting characters, numerical values, various instructions, and the like. The pointing device 212 is an example of an input device (input means) that allows a user to select or execute various instructions, select an object for processing, or move a cursor being displayed. In another example, the input device (input means) includes at least one of a touch panel or a voice input apparatus, in addition to or in alternative to the keyboard 211 and the pointing device 212. The DVD-RW drive 214 controls reading or writing of various data from or to a DVD-RW 213, which is an example of a removable storage medium. In another example, the removable storage medium includes at least one of digital versatile disk-recordable (DVD-R) or a Blu-ray® disk, in addition to or in alternative to the DVD-RW. The medium I/F 216 controls reading or writing of data from or to a storage medium 215 such as a flash memory.

The communication terminal 3 is implemented a computer. Of these hardware resources, as illustrated in FIG. 2, a CPU 301 to a medium I/F 316 have the same or substantially the same configuration as the hardware resources of the CPU 201 to the medium I/F 216 of the event management apparatus 2, and the redundant detailed descriptions thereof are omitted below. The communication terminal 3 further includes an audio input/output I/F 317, a microphone 318, and a speaker 319. The microphone 318 is an example of a built-in sound collecting device configured to receive an input of sound (audio signal). The speaker 319 is an example of a sound output device configured to output sound (audio signal). The audio input/output I/F 317 is a circuit for controlling input and output of audio signals between the microphone 318 and the speaker 319 under control of the CPU 301.

The computer illustrated in FIG. 2 is merely one example of the communication terminal 3. Other example of the communication terminal 3 include, but are not limited to, a head up display (HUD) device, an industrial machine, a networked home appliance, a mobile phone, a smartphone, a tablet terminal, a game console, and a personal digital assistant (PDA).

In one example, any one of the above-described control programs is recorded in a file in a format installable or executable on a computer-readable storage medium or is downloaded through a network for distribution. Examples of the storage medium include, but are not limited to, a compact disk recordable (CD-R), a digital versatile disk (DVD), a Blu-ray® disk, a secure digital (SD) card, and a USB memory. In another example, such storage medium is provided in domestic markets or foreign markets as program products. For example, the event management apparatus 2 implements an event management method according to the present disclosure by executing a program according to the present disclosure.

Hardware Configuration of Shared Terminal:

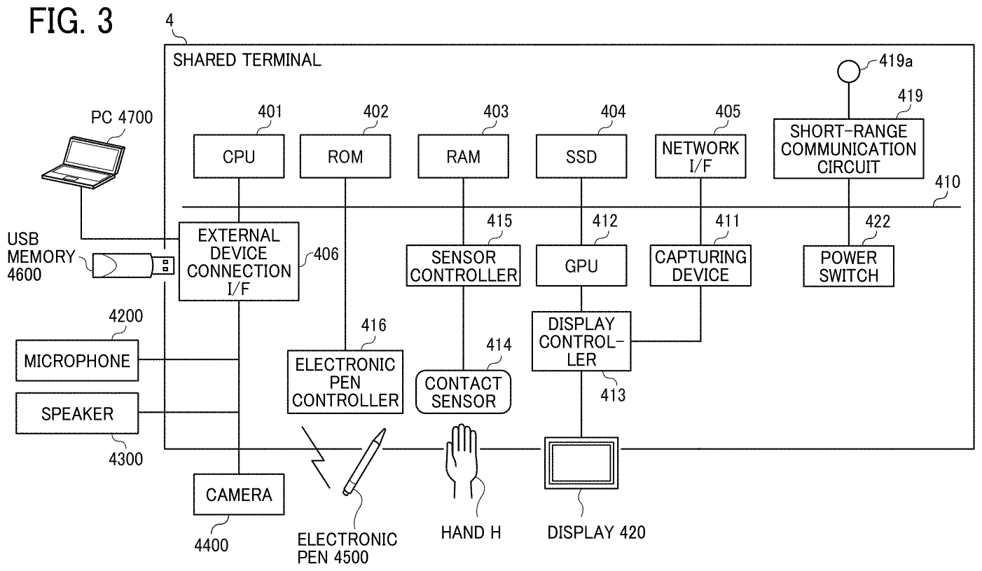

FIG. 3 is a block diagram illustrating an example of a hardware configuration of the shared terminal 4. As illustrated in FIG. 3, the shared terminal 4 includes a CPU 401, a ROM 402, a RAM 403, a solid state drive (SSD) 404, a network I/F 405, and an external device connection I/F 406.

The CPU 401 controls overall operation of the shared terminal 4. The ROM 402 stores programs such as an initial program loader (IPL) to boot the CPU 401. The RAM 403 is used as a work area for the CPU 401. The SSD 404 stores various data such as a control program for the shared terminal 4. The network I/F 405 controls communication with external devices through the communication network 100. The external device connection I/F 406 controls communication with a USB memory 4600, a PC 4700, and external devices (a microphone 4200, a speaker 4300, and a camera 4400). The shared terminal 4 further includes a capturing device 411, a graphics processing unit (GPU) 412, a display controller 413, a contact sensor 414, a sensor controller 415, an electronic pen controller 416, a short-range communication circuit 419, an antenna 419a for the short-range communication circuit 419, and a power switch 422.

The capturing device 411 acquires image data of an image displayed on a display 420 under control of the display controller 413, and stores the image data in the RAM 403 or the like. The display 420 is an example of a display device (display means). The GPU 412 is a semiconductor chip dedicated to processing of a graphical image. The display controller 413 controls and manages a screen display to output an image output from the capturing device 411 or the GPU 412 to the display 420, for example. The contact sensor 414 detects a touch onto the display 420 with the electronic pen 4500 or a user's hand H. The sensor controller 415 controls operation of the contact sensor 414. The contact sensor 414 senses a touch input to a specific coordinate on the display 420 using the infrared blocking system. More specifically, the display 420 is provided with two light receiving elements disposed on both upper side ends of the display 420, and a reflector frame surrounding the sides of the display 420. The light receiving elements emit a plurality of infrared rays in parallel to a surface of the display 420. The light receiving elements receive lights passing in the direction that is the same as an optical path of the emitted infrared rays, which are reflected by the reflector frame. The contact sensor 414 outputs an identifier (ID) of the infrared ray that is blocked by an object after being emitted from the light receiving elements, to the sensor controller 415. Based on the ID of the infrared ray, the sensor controller 415 detects a specific coordinate that is touched by the object. The electronic pen controller 416 communicates with the electronic pen 4500 to detect contact by the tip or bottom of the electronic pen with the display 420. The short-range communication circuit 419 is a communication circuit that communicates in compliance with the near field communication (NFC) and the Bluetooth®, for example. The power switch 422 is a switch that turns on or off the power of the shared terminal 4.

The shared terminal 4 further includes a bus line 410. Examples of the bus line 410 include, but are not limited to, an address bus and a data bus, which electrically connects the elements such as the CPU 401 illustrated in FIG. 3 with each other.

The contact sensor 414 is not limited to the infrared blocking system type, and may be a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. In addition to or in alternative to detecting a touch by the tip or bottom of the electronic pen 4500, the electronic pen controller 416 may also detect a touch by another part of the electronic pen 4500, such as a part held by a hand of the user.

Functional Configuration of Event Management System:

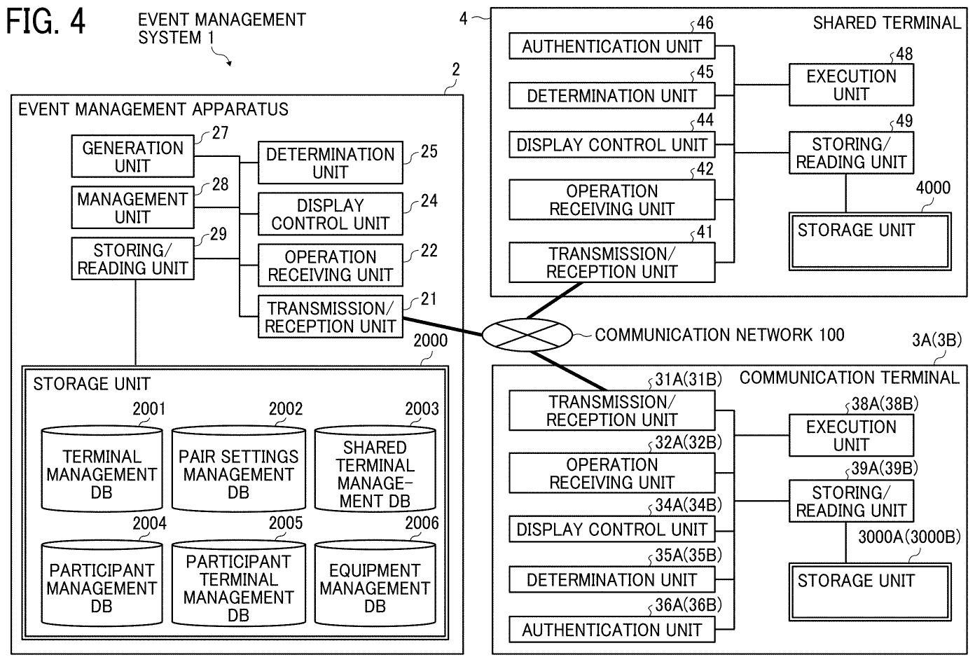

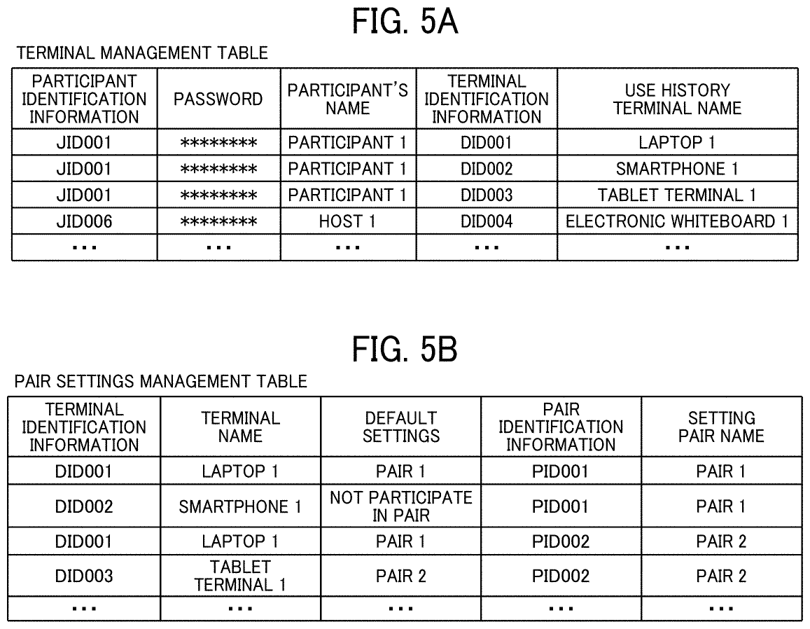

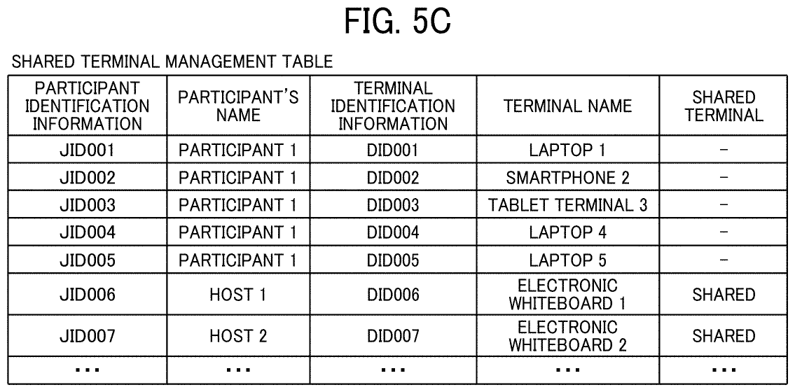

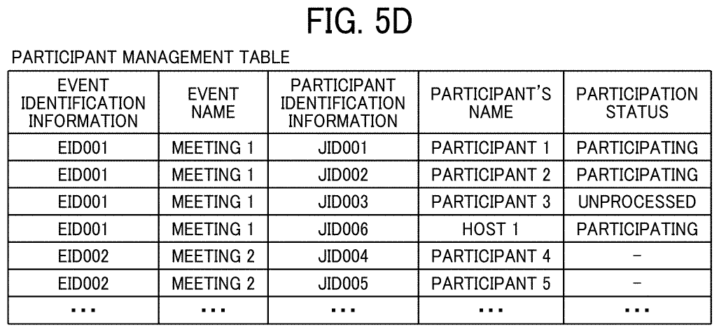

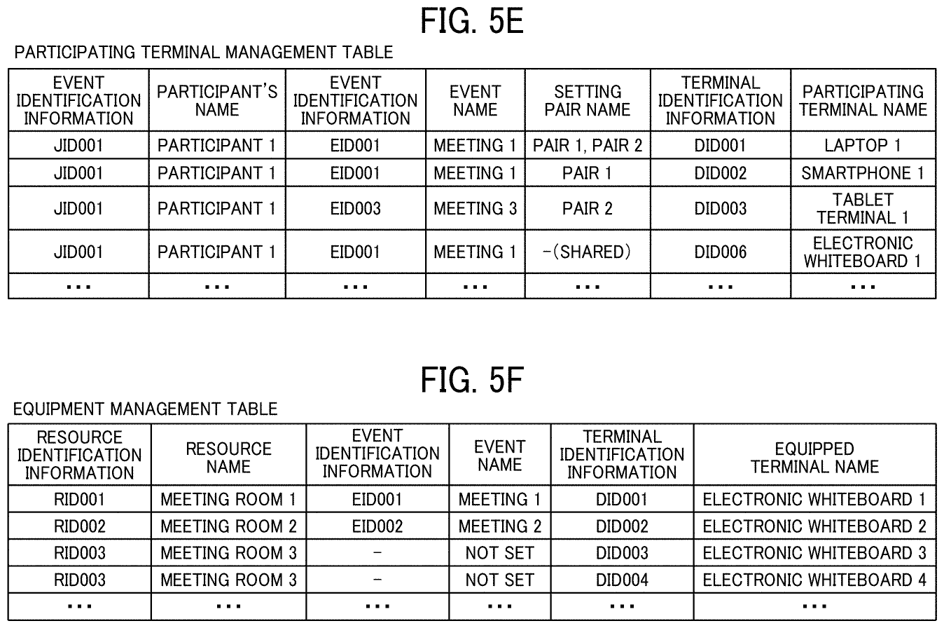

Referring to FIG. 4 and FIG. 5 (FIG. 5A to FIG. 5F), a functional configuration according to an embodiment is described. FIG. 4 is a block diagram illustrating an example of a functional configuration of the event management system 1.

Functional Configuration of Event Management Apparatus:

As illustrated in FIG. 4, the event management apparatus 2 includes a transmission/reception unit 21, an operation receiving unit 22, a display control unit 24, a determination unit 25, a generation unit 27, and a storing/reading unit 29. These units are functions that are implemented by or that are caused to function by operating any of the hardware resources illustrated in FIG. 2 in cooperation with instructions of the CPU 201 according to the program dedicated to the event management apparatus 2 expanded to the RAM 203 from at least one of the ROM 202 and the HD 204. The event management apparatus 2 further includes a storage unit 2000 implemented by at least one of the ROM 202 and the HD 204 illustrated in FIG. 2.

Terminal Management Table:

FIG. 5A is a conceptual diagram illustrating an example of a terminal management table. In the storage unit 2000, a terminal management database (DB) 2001 is stored, in the form of the terminal management table as illustrated in FIG. 5A. The terminal management table stores and manages, for each participant identification information, a participant's name, a terminal identification information, and a use history terminal name in association with one another. The participant identification information is information for identifying a participant who participates in a certain event. As the participant identification information, JID001, JID002, and the like are given, for example.

The participant's name represents a participant who participates in a certain event. As the participant's name, Participant 1, Host 1, and the like are given, for example.

The terminal identification information is information for identifying communication terminals (also referred to as “devices”) used by participants in a certain event. As the terminal identification information, DID001, DID002, and the like are given for example. The use history terminal name indicates which communication terminal is used by the participant associated with the corresponding participant's name to participate in the event in the past. As the use history terminal name, Laptop 1, Smartphone 1, Tablet terminal 1, and Electronic whiteboard 1, and the like are given, for example. In the example of FIG. 5A, a record is stored indicating that Participant 1 participated in a certain event using Laptop 1, Smartphone 1, and Tablet terminal 1 in the past.

Pair Settings Management Table:

FIG. 5B is a conceptual diagram illustrating an example of a pair settings management table. In the storage unit 2000, a pair settings management DB 2002 is stored, in the form of the pair settings management table as illustrated in FIG. 5B. The pair settings management table stores and manages, for each terminal identification information, a terminal name, default settings, pair identification information, and a setting pair name in association with one another. As the terminal name, the use history terminal name associated with the terminal identification information stored in the terminal management DB 2001 (see FIG. 5A) is stored as the communication terminal associated with the terminal identification information stored in the pair settings management table.

The default settings indicate, for each communication terminal, which communication terminal is to be paired by default. The default setting is an item that the participant can set in advance, such as that Laptop 1 participates as Pair 1, Smartphone 1 does not participate in a pair, and Tablet terminal 1 participates as Pair 2.

The pair identification information is information for identifying a pair group. As the pair identification, PID001, PID002, and the like are given, for example. The setting pair name indicates which communication terminals are actually used as a pair of which setting pair name. As the setting pair name, Pair 1, Pair 2, and the like are given, for example. In the example of FIG. 5B, Laptop 1 and Smartphone 1 are managed as Pair 1, and Laptop 1 and Tablet terminal 1 are managed as Pair 2.

Shared Terminal Management Table:

FIG. 5C is a conceptual diagram illustrating an example of a shared terminal management table. In the storage unit 2000, a shared terminal management DB 2003 is stored, in the form of the shared terminal management table as illustrated in FIG. 5C. The shared terminal management table stores and manages, for each participant identification information, a participant's name, terminal identification information, a terminal name, and a shared terminal in association with one another. The descriptions provided above with reference to FIG. 5A and FIG. 5B for the participant identification information, the participant's name, the terminal identification information, and the terminal name of the terminal management DB 2001 and the pair settings management DB 2002 apply to the participant identification information, the participant's name, the terminal identification information, and the terminal name of the shared terminal management table. The shared terminal refers to a communication terminal that a plurality of participants who participate in a certain event can jointly use or share, in addition to a communication terminal individually used by a participant, when a communication terminal represented by a terminal name is used in the certain event. In other words, in the present embodiment, Electronic whiteboard 1 and Electronic whiteboard 2 installed or located in a resource (e.g., a conference room) where a certain event is held serves as the shared terminals.

Participant Management Table:

FIG. 5D is a conceptual diagram illustrating an example of a participant management table. In the storage unit 2000, a participant management DB 2004 is stored, in the form of the participant management table as illustrated in FIG. 5D. The participant management table stores and manages, for each event identification information, an event name, participant identification information, a participant's name, and a participation status in association with one another. The event identification information is information for identifying an event held on a certain date and time. As the event identification information, EID001, EID002, and the like are given, for example. As the participation status, a check-in state and a check-out state are managed, for example. The check-in state indicates whether a participant who is scheduled to participate in an event represented by an event name actually participates in the event. The check-out state indicates whether the participant has left the event.

Participating Terminal Management Table:

FIG. 5E is a conceptual diagram illustrating an example of a participating terminal management table. In the storage unit 2000, a participating terminal management DB 2005 is stored, in the form of the participating terminal management table as illustrated in FIG. 5E. The participating terminal management table stores and manages, for each participant identification information, a participant's name, event identification information, an event name, a setting pair name, terminal identification information, and a participating terminal name in association with one another. The setting pair name is a name of a pair to which the communication terminal managed by the participating terminal name is set. For example, among the participating terminal names managed by this participating terminal management table, Pair 1 and Pair 2 are set for Laptop 1. In this case, a counterpart of Laptop 1 in Pair 1 is Smartphone 1. In other words, Pair 1 is set for a pair of Smartphone 1 and Laptop 1. Further, Pair 2 is set for Tablet terminal 1. In this case, a counterpart of Tablet terminal 1 in Pair 2 is Laptop 1. In other words, Laptop 1 is used in both events of Meeting 1 and Meeting 3. Further, no pair is set for Electronic whiteboard 1. Electronic whiteboard 1 is treated as the shared terminal. Since as described above, the participating terminal management table manages the setting pair name, the participating terminal management table may be managed in association with the pair settings management DB 2002 (see FIG. 5B).

Equipment Management Table:

FIG. 5F is a conceptual diagram illustrating an example of an equipment management table. In the storage unit 2000, an equipment management DB 2006 is stored, in the form of the equipment management table as illustrated in FIG. 5F. The equipment management table stores and manages, for each resource identification information, a resource name, event identification information, an event name, terminal identification information, and an equipped terminal name in association with one another. The resource identification information is information for identifying a particular resource. As the resource identification information, RID001, RID002, and the like are given, for example. The resource name indicates a name of a resource in which a certain event is held. As the resource name, Meeting room 1, Meeting room 2, and the like are given, for example. The equipped terminal name is a name of a terminal installed or provided in the resource associated with the corresponding resource name. As the equipped terminal name, Electronic whiteboard 1, Electronic whiteboard 2, and the like are given, for example.

Each Functional Unit of Event Management Apparatus:

A description is now given of each of the functional units of the event management apparatus 2 in detail. The transmission/reception unit 21 of the event management apparatus 2 illustrated in FIG. 4 is mainly implemented by the external device connection I/F 208 and the network I/F 209 that operate according to instructions of the CPU 201 illustrated in FIG. 2. The transmission/reception unit 21 transmits and receives various data (or information) to and from the communication terminal 3 and the shared terminal 4 through the communication network 100. In the present embodiment, the transmission/reception unit 21 functions as an example of at least one of a transmission unit (transmission means) or a reception unit (reception means).

The operation receiving unit 22 is mainly implemented by the CPU 201 processing signals received from the keyboard 211 and the pointing device 212 illustrated in FIG. 2. The operation receiving unit 22 receives various operations and an input for selection from an administrator who manages the event management apparatus 2. In another example, as the operation receiving unit 22, an operation button having a user interface (UI) to be pressed or be tapped is used as an input device (input means), in addition to the keyboard 211 and the pointing device 212. In the present embodiment, the operation receiving unit 22 functions as an example of operation receiving means.

The display control unit 24 is mainly implemented by the display 206 that operates according to instructions of the CPU 201 illustrated in FIG. 2. The display control unit 24 performs display control of various data (information) to be displayed on the display 206. In the present embodiment, the display control unit 24 functions as an example of display control means.

The determination unit 25, which is mainly implemented by instructions of the CPU 201 illustrated in FIG. 2, performs various determinations in the event management apparatus 2. In the present embodiment, the determination unit 25 functions as an example of determination means.

The generation unit 27, which is mainly implemented by instructions of the CPU 201 illustrated in FIG. 2, generates various information to be transmitted to the communication terminal 3 and the shared terminal 4. In the present embodiment, the generation unit 27 functions as an example of generation means.

The management unit 28, which is mainly implemented by instructions of the CPU 201 illustrated in FIG. 2, manages participation (check-in) of the communication terminal 3 and the shared terminal 4 in a certain event and exit (check-out) from the certain event based on the participant identification information, the user identification information, and the terminal name transmitted by the communication terminal 3 and the shared terminal 4. Further, the management unit 28 manages (searches for) a terminal used in the past based on the participant identification information. In the present embodiment, the management unit 28 functions as an example of management means.

The storing/reading unit 29, which is mainly implemented by instructions of the CPU 201 illustrated in FIG. 2, stores various data (or information) in the storage unit 2000 and reads various data (or information) from the storage unit 2000. In the present embodiment, the storing/reading unit 29 functions as an example of storing/reading means.

Functional Configuration of Communication Terminal:

As illustrated in FIG. 4, the communication terminal 3 includes a transmission/reception unit 31A (31B), an operation receiving unit 32A (32B), a display control unit 34A (34B), a determination unit 35A (35B), an authentication unit 36A (36B), an execution unit 38A (38B), and a storing/reading unit 39A (39B). To simplify the description, these functional units of the communication terminal 3 are referred to as a transmission/reception unit 31, an operation receiving unit 32, a display control unit 34, a determination unit 35, an authentication unit 36, an execution unit 38, and a storing/reading unit 39, unless they need to be distinguished from one to another. These units are functions that are implemented by or that are caused to function by operating any of the hardware resources illustrated in FIG. 2 in cooperation with instructions of the CPU 201 according to the program dedicated to the communication terminal 3 expanded to the RAM 203 from at least one of the ROM 202 and the HD 204. The communication terminal 3 further includes a storage unit 3000, which is implemented by at least one of the ROM 202 and the HD 204 illustrated in FIG. 2. The storage unit 3000 stores a communication processing program to be executed by the communication terminal 3. Further, in the storage unit 3000, a communication application and a meeting application are installed and managed. The communication application allows, when executed, the communication terminal 3 to communicate with the event management apparatus 2 and the shared terminal 4. The meeting application allows, when executed, the communication terminal 3 to perform an online meeting.

Each Functional Unit of Communication Terminal:

A description is now given of each of the functional units of the communication terminal 3 in detail. The transmission/reception unit 31 of the communication terminal 3 illustrated in FIG. 4 is mainly implemented by the external device connection I/F 308 and the network I/F 309 that operate according to instructions of the CPU 301 illustrated in FIG. 2. The transmission/reception unit 31 transmits and receives various data (or information) to and from the event management apparatus 2 through the communication network 100. In the present embodiment, the transmission/reception unit 31 functions as an example of at least one of a transmission unit (transmission means) or a reception unit (reception means).

The operation receiving unit 32 is mainly implemented by the CPU 301 processing signals received from the keyboard 311 and the pointing device 312 illustrated in FIG. 2. The operation receiving unit 32 receives various operations and an input for selection from a user. In another example, as the operation receiving unit 32, an operation button having a UI to be pressed or be tapped is used as an input device (input means), in addition to the keyboard 311 and the pointing device 312. In the present embodiment, the operation receiving unit 32 functions as an example of operation receiving means.

The display control unit 34 is mainly implemented by the display 306 that operates according to instructions of the CPU 301 illustrated in FIG. 2. The display control unit 34 controls the display 306 to display various images, characters, and code information, for example. In the present embodiment, the display control unit 34 functions as an example of display control means.

The determination unit 35, which is mainly implemented by instructions of the CPU 301 illustrated in FIG. 2, performs various determinations in the communication terminal 3. In the present embodiment, the determination unit 35 functions as an example of determination means.

The authentication unit 36 is mainly implemented by instructions of the CPU 301 illustrated in FIG. 2. The authentication unit 36 performs login processing (request) in response to an input of user identification information and a password, for example, when a user using the communication terminal 3 requests authentication to the event management apparatus 2. In the present embodiment, the authentication unit 36 functions as an example of authentication means.

The execution unit 38, which is mainly implemented by instructions of the CPU 301 illustrated in FIG. 2, performs processing for participating in various events in the communication terminal 3. In the present embodiment, the execution unit 38 functions as an example of execution means.

The storing/reading unit 39 is mainly implemented by at least one of the ROM 302 and the HD 304 that operate according to instructions of the CPU 301 illustrated in FIG. 2. The storing/reading unit 39 stores various data (or information) in the storage unit 3000 or reads various data (or information) from the storage unit 3000. In the present embodiment, the storing/reading unit 39 functions as an example of storing/reading means.

Functional Configuration of Shared Terminal:

As illustrated in FIG. 4, the shared terminal 4 includes a transmission/reception unit 41, an operation receiving unit 42, a display control unit 44, a determination unit 45, an authentication unit 46, an execution unit 48, and a storing/reading unit 49. These units are functions that are implemented by or that are caused to function by operating any of the hardware resources illustrated in FIG. 3 in cooperation with instructions of the CPU 401 according to the program dedicated to the shared terminal 4 expanded to the RAM 403 from at least one of the ROM 402 and the SSD 404. The shared terminal 4 further includes a storage unit 4000, which is implemented by at least one of the ROM 402 and the SSD 404 illustrated in FIG. 3. Further, in the storage unit 4000, a communication processing program to be executed by the shared terminal 4 is stored. Further, in the storage unit 4000, a communication application and a meeting application are installed and managed. The communication application allows, when executed, the shared terminal 4 to communicate with the event management apparatus 2 and the communication terminal 3. The meeting application allows, when executed, the shared terminal 4 to perform an online meeting.

Each Functional Unit of Shared Terminal:

A description is now given of each of the functional units of the shared terminal 4 in detail. The transmission/reception unit 41 of the shared terminal 4 illustrated in FIG. 4 is mainly implemented by the external device connection I/F 406 and the short-range communication circuit 419 that operate according to instructions of the CPU 401 illustrated in FIG. 3. The transmission/reception unit 41 transmits and receives various data (or information) to and from the event management apparatus 2 and the communication terminal 3 through the communication network 100. In the present embodiment, the transmission/reception unit 41 functions as an example of at least one of a transmission unit (transmission means) or a reception unit (reception means).

The operation receiving unit 42 is mainly implemented by the CPU 401 processing signals received from the electronic pen controller 416, the contact sensor 414, and the sensor controller 415 illustrated in FIG. 3. The operation receiving unit 42 receives operations and selections by a user, and an input of information that is input with an electronic pen and a user's body such as a user's finger or hand, for example. In another example, as the operation receiving unit 42, an operation button having a UI to be pressed or be tapped is used as an input device (input means), in addition to the input with the electronic pen or the user's body. In the present embodiment, the operation receiving unit 42 functions as an example of operation receiving means.

The display control unit 44 is mainly implemented by the display 420 and the display controller 413 that operate according to instructions of the CPU 401 illustrated in FIG. 3. The display control unit 44 controls the display 420 to display various images, characters, numbers, and code information, for example. In the present embodiment, the display control unit 44 functions as an example of display control means.

The determination unit 45, which is mainly implemented by instructions of the CPU 401 illustrated in FIG. 3, performs various determinations in the shared terminal 4. In the present embodiment, the determination unit 45 functions as an example of determination means.

The authentication unit 46 is mainly implemented by instructions of the CPU 401 illustrated in FIG. 3. The authentication unit 46 performs login processing (request) in response to an input of user identification information and a password, for example, when a user using the shared terminal 4 requests authentication to the event management apparatus 2. In the present embodiment, the authentication unit 46 functions as an example of authentication means.

The execution unit 48, which is mainly implemented by instructions of the CPU 401 illustrated in FIG. 3, performs processing for participating in various events in the shared terminal 4. In the present embodiment, the execution unit 48 functions as an example of execution means.

The storing/reading unit 49 is mainly implemented by at least one of the ROM 402 and the SSD 404 that operate according to instructions of the CPU 401 illustrated in FIG. 3. The storing/reading unit 49 stores various data (or information) in the storage unit 4000 or reads various data (or information) from the storage unit 4000. In the present embodiment, the storing/reading unit 49 functions as an example of storing/reading means.

Processes or Operation of Embodiments:

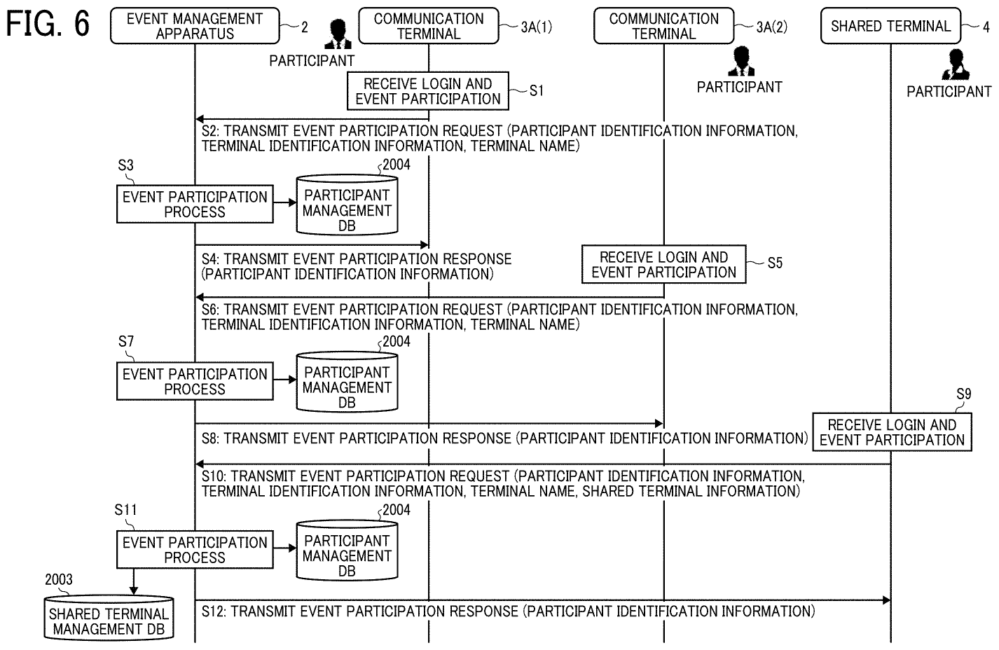

Referring to FIG. 6 to FIG. 19, processes and operation performed by the event management system 1 are described according to the first embodiment. FIG. 6 is a sequence diagram illustrating an example of operation of login and participating in an event.

Operation of Login and Participating in Event:

First, Participant 1, who is to participate in an event, inputs a request for a login and event participation to Laptop 1, which is an example of the communication terminal 3A(1) used by Participant 1. Thus, the operation receiving unit 32(1) of Laptop 1 receives the request for login and event participation input by Participant 1 (step S1).

Subsequently, the transmission/reception unit 31(1) transmits an event participation request to the event management apparatus 2 (step S2). Thus, the event management apparatus 2 receives the event participation request transmitted by the communication terminal 3A(1). This event participation request includes participant identification information, terminal identification information, and a terminal name, i.e., “Laptop 1”.

In response to receiving the event participation request, the management unit 28 of the event management apparatus 2 performs an event participation processing for Laptop 1 (step S3). Specifically, the management unit 28 cooperates with the storing/reading unit 29, to register the received “Participant 1”, “DID001”, and “Laptop 1” respectively in the fields of the participant's name, the terminal identification information, and the use history terminal name associated with the participant identification information of the terminal management DB 2001 (see FIG. 5A).

After performing the event participation process, the transmission/reception unit 21 transmits an event participation response to the communication terminal 3A(1) (step S4). Thus, the transmission/reception unit 31(1) of the communication terminal 3A(1) receives the event participation response transmitted by the event management apparatus 2. This event participation response may include the participant identification information.

In substantially the same manner, the processes from step S1 to step S4 described above are performed for the communication terminal 3A(2), which is used by Participant 1. In other words, Participant 1 inputs a request for a login and event participation process to Smartphone 1, which is an example of the communication terminal 3A (2) used by Participant 1. Thus, the operation receiving unit 32(2) of Smartphone 1 receives the request for login and event participation input by Participant 1 (step S5).

Subsequently, the transmission/reception unit 31(2) transmits an event participation request to the event management apparatus 2 (step S6). Thus, the event management apparatus 2 receives the event participation request transmitted by the communication terminal 3A(2). This event participation request includes participant identification information, terminal identification information, and a terminal name, i.e., “Smartphone 1”.

In response to receiving the event participation request, the management unit 28 of the event management apparatus 2 performs an event participation processing for Smartphone 1 (step S7). Specifically, the management unit 28 cooperates with the storing/reading unit 29, to register the received “Participant 1”, “DID002”, and “Smartphone 1” respectively in the fields of the participant's name, the terminal identification information, and the use history terminal name associated with the participant identification information of the terminal management DB 2001 (see FIG. 5A).

After performing the event participation process, the transmission/reception unit 21 transmits an event participation response to the communication terminal 3A(2) (step S8). Thus, the transmission/reception unit 31(2) of the communication terminal 3A(2) receives the event participation response transmitted by the event management apparatus 2. This event participation response may include the participant identification information.

Further, in substantially the same manner, the processes from step S1 to step S4 described above are performed for the shared terminal 4, which is used by Host 1, who organizes the event. In other words, Host 1 inputs a request for a login and event participation process to Electronic whiteboard 1, which is an example of the shared terminal 4 used by Host 1. Thus, the operation receiving unit 42 of Electronic whiteboard 1 receives the request for login and event participation input by Host 1 (step S9).

Subsequently, the transmission/reception unit 41 transmits an event participation request to the event management apparatus 2 (step S10). Thus, the event management apparatus 2 receives the event participation request transmitted by the shared terminal 4. This event participation request includes participant identification information, terminal identification information, and a terminal name, i.e., “Electronic whiteboard 1”.

In response to receiving the event participation request, the management unit 28 of the event management apparatus 2 performs an event participation processing for Electronic whiteboard 1 (step S11). Specifically, the management unit 28 cooperates with the storing/reading unit 29, to register the received “Host 1”, “DID004”, and “Electronic whiteboard 1” respectively in the fields of the participant's name, the terminal identification information, and the use history terminal name associated with the participant identification information of the terminal management DB 2001 (see FIG. 5A).

After performing the event participation process, the transmission/reception unit 21 transmits an event participation response to the shared terminal 4 (step S12). Thus, the transmission/reception unit 41 of the shared terminal 4 receives the event participation response transmitted by the event management apparatus 2. This event participation response may include the participant identification information.

The description given above is of an example in which the processes from step S1 to step S12 is performed with respect to each of the communication terminals used by Participant 1, the processes performed in substantially the same manner even in a case that any other participant participates in an event. In this case, the participant identification information and the participant's name to be registered in the participant management DB 2004 (see FIG. 5D) are changed and registered.

In addition, in the following description, the functional units described as the functional units of the communication terminal 3A (1) and the communication terminal 3A (2) described above are referred to as the functional units of the communication terminal 3, for the sake of explanatory convenience.

In another example, in the event management system 1 according to the present embodiment, another apparatus intervenes between the communication terminal 3A (1) and the event management apparatus 2 and between the communication terminal 3A (2) and the event management apparatus in execution of the processes of steps S2 and S4, steps S6 and S8, and steps S10 and S12. In other words, various information (data) transmitted and received between the communication terminal 3 and the event management apparatus 2 may be transmitted and received via another apparatus. The above-described configuration and operation may also be applied to other processing steps between each of the communication terminals 3 and the event management apparatus 2.

Example of Screen Display:

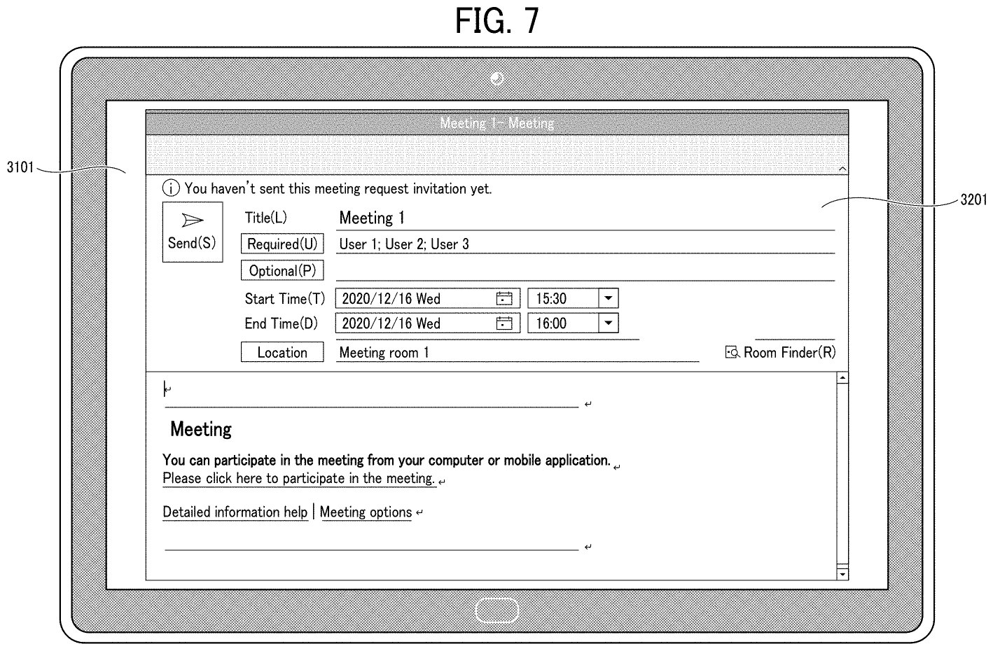

FIG. 7 illustrates an example of a screen displayed when making a reservation for an online meeting. As illustrated in FIG. 7, in step S1, Participant 1 operates, for example, the communication terminal 3 (Laptop 1), to control the display 306 to display an “Online meeting reservation” dialog 3201. Specifically, when the operation receiving unit 32 receives an operation for participating in an event by Participant 1, the display control unit 34 executes the meeting application installed in the communication terminal 3, to control the display 306 to display the “Online meeting reservation” dialog 3201 on a display screen 3101. In the “Online meeting reservation” dialog 3201, items including, for example, a title of an event to be held (in this example, “Meeting 1”), a start time, an end time, and a location (in this example, “Meeting room 1”) are displayed. The “Online meeting reservation” dialog 3201 further includes an information link including a link (in this example, “Please click here to participate in the meeting”) for participating in a meeting added by Participant 1. The “Online meeting reservation” dialog 3201 is displayed on the communication terminal 3A(2) and the shared terminal 4 in the processes of step 5 and step S9 in substantially the same manner.

Operation of Adding Pair and Starting Configuring Settings:

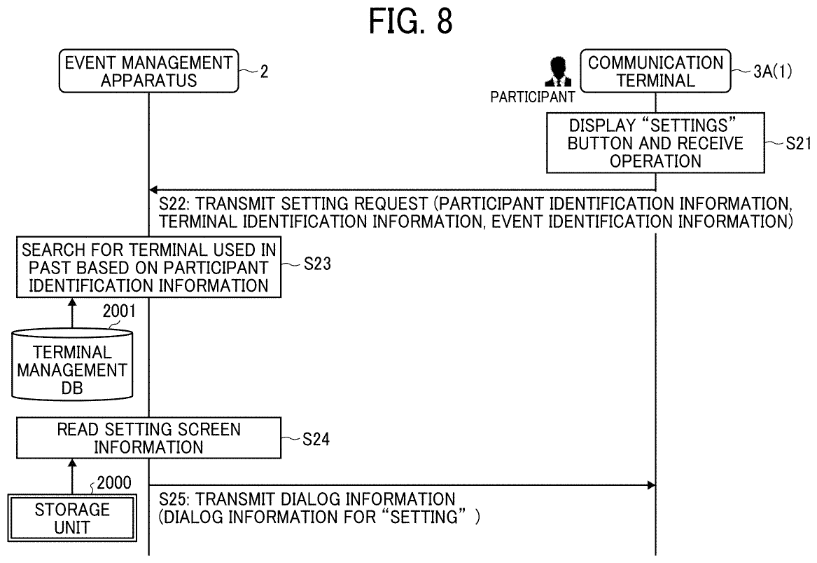

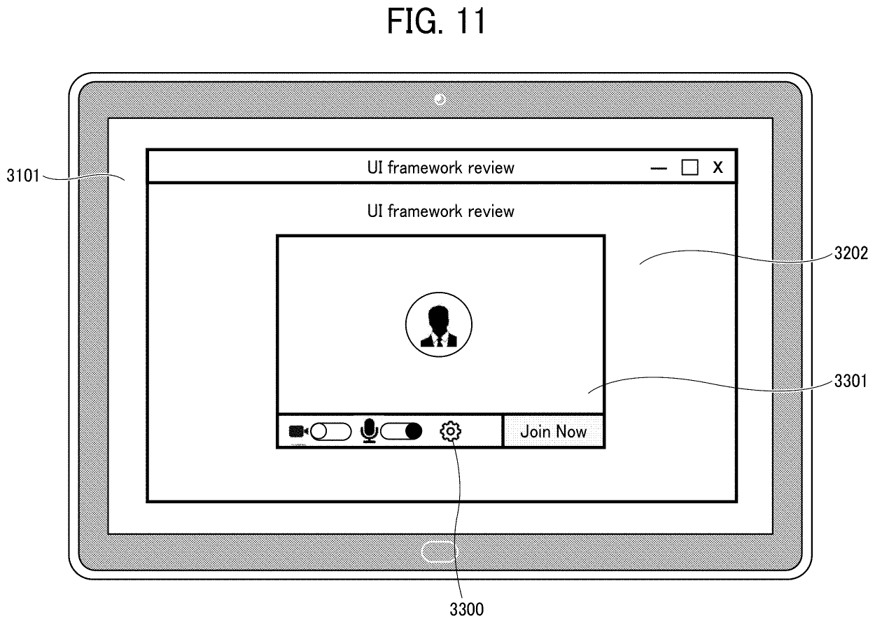

A description is now given of operation of adding a pair of communication terminals and configuring settings according to a user's operation. FIG. 8 is a sequence diagram illustrating an example of operation of starting a pairing setting. As illustrated in FIG. 8, the display control unit 34 of the communication terminal 3 controls the display 306 to display a “UI framework review dialog” 3202, which is described below, on the display screen 3101. Then, the operation receiving unit 32 receives selection of a “Setting button” 3300 (a gear icon in FIG. 11 described below) by the participant (step S21).

Subsequently, the transmission/reception unit 31 transmits a setting request to the event management apparatus 2 (step S22). Thus, the transmission/reception unit 21 of the event management apparatus 2 receives the setting request transmitted by the communication terminal 3. This setting request includes participant identification information, terminal identification information, and event identification information. The event identification information is stored in the communication terminal 3 in association with, for example, the “Online meeting reservation” dialog 3201 displayed in step S21 and the “UI framework review dialog” 3202.

In response to receiving the setting request, the event management apparatus 2 searches for a terminal used in the past based on the participant identification information (step S23). Specifically, the management unit 28 cooperates with the storing/reading unit 29, to searches the terminal management DB 2001 (see FIG. 5A) using the received participant identification information as a search key, to read the use history terminal name associated with the participant identification information. Thus, the management unit 28 retrieves the communication terminal associated with the participant identification information. The number of retrieved usable terminals is not limited one for the same participant.

Subsequently, the storing/reading unit 29 reads setting screen information stored and managed in a predetermined area in the storage unit 2000 (step S24). The transmission/reception unit 21 transmits, to the communication terminal 3, dialog information for configuring a dialog box (in the following description, simply referred to as a “dialog”) included in the setting screen information that is read in step S24 (step S25). Thus, the transmission/reception unit 31 of the communication terminal 3 receives the dialog information transmitted by the event management apparatus 2. This dialog information includes dialog information for “setting”.

Example of Screen Display:

FIG. 11 illustrates an example of a screen displayed when participating in an online meeting. As illustrated in FIG. 11, the display control unit 34 of the communication terminal 3 controls the display 306 to display a “UI framework review dialog” 3202 on the display screen 3101. In the “UI framework review dialog” 3202, the “setting button” 3300 and an “Join Now” button 3301 are displayed. The participant operates these buttons as needed to cause a screen currently being displayed to transition to a different screen. In the present embodiment, the “Join Now” button 3301 functions as an example of event starting means.

Operation of Adding Pair and Configuring Settings:

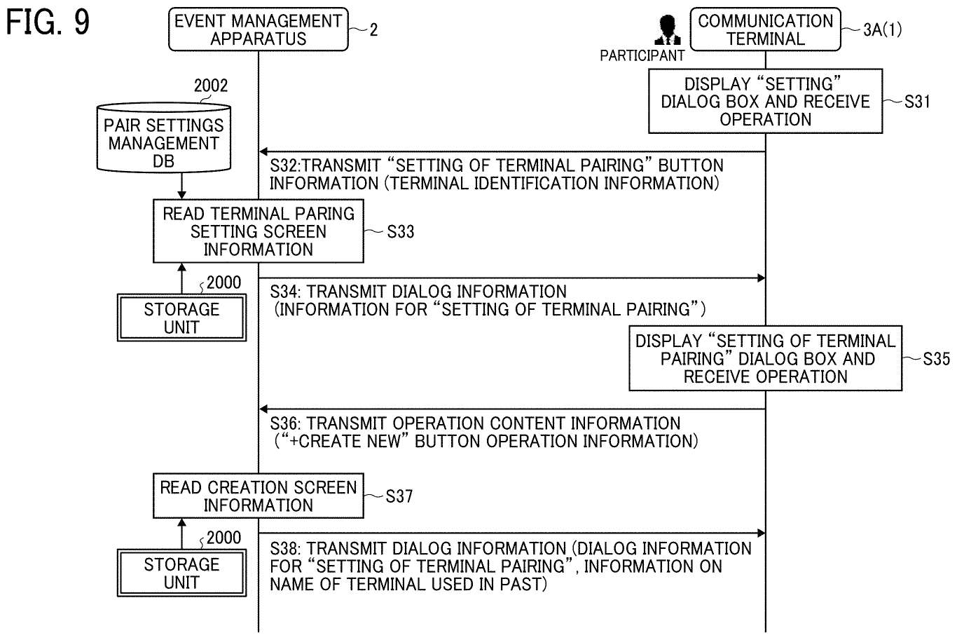

FIG. 9 is a sequence diagram illustrating an example of operation of configuring terminal pairing settings. As illustrated in FIG. 9, the display control unit 34 of the communication terminal 3 controls the display 306 to display a “Setting” dialog 3203, which is described below, on the display screen 3101. Then, the operation receiving unit 32 receives selection of a “Setting of terminal pairing” button 3303 by the participant (step S31). In the present embodiment, the “Setting of terminal pairing” button 3303 functions as an example of terminal paring setting receiving means or a graphical representation for setting the one communication terminal and another communication terminal in association with each other.

Example of Screen Display:

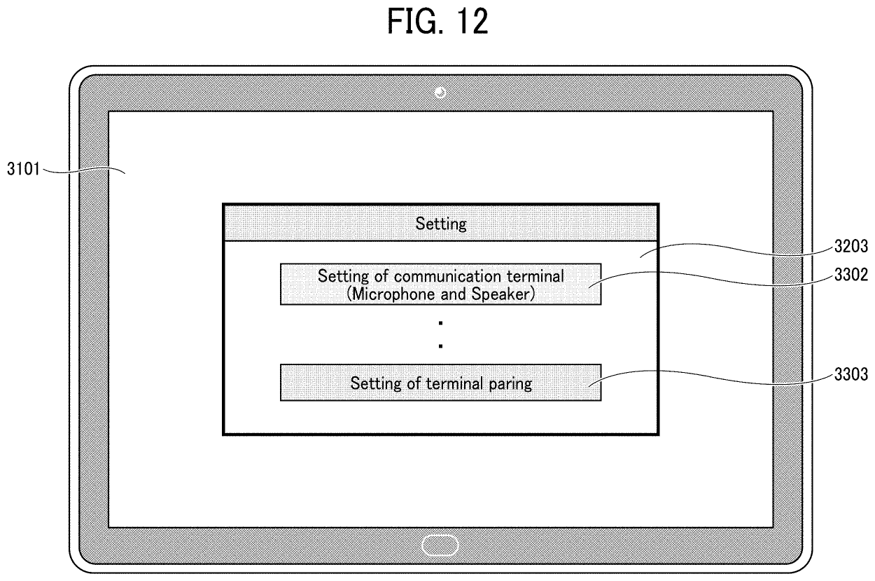

FIG. 12 illustrates an example of a screen display of a dialog for selecting a terminal pairing setting. As illustrated in FIG. 12, the display control unit 34 of the communication terminal 3 controls the display 306 to display the “Setting” dialog 3203 on the display screen 3101. In the “Setting” dialog 3203, various setting buttons are displayed including a “Setting of communication terminal (microphone/speaker)” button 3302 and the “Setting of terminal pairing” button 3303. The participant operates these buttons as needed to cause a screen currently being displayed to transition to a different screen.

Referring again to FIG. 9, the transmission/reception unit 31 transmits terminal pairing setting button information to the event management apparatus 2 (step S32). Thus, the transmission/reception unit 21 of the event management apparatus 2 receives the terminal pairing setting button information transmitted by the communication terminal 3. This terminal pairing setting button information includes the terminal identification information.

In response to receiving the terminal pairing setting button information, the storing/reading unit 29 of the event management apparatus 2 reads out terminal pairing setting information (step S33). Specifically, the storing/reading unit 29 searches the pair settings management DB 2002 (see FIG. 5B) using the received terminal identification information as a search key, to read the setting pair name associated with the terminal identification information (e.g., pair 1, pair 2). The setting pair name read in step S33 is a setting pair name that is set by default. Further, the storing/reading unit 29 reads terminal pairing setting screen information stored and managed in a predetermined area in the storage unit 2000.

Subsequently, the transmission/reception unit 21 transmits dialog information based on the read setting pair name to the communication terminal 3 (step S34). Thus, the transmission/reception unit 31 of the communication terminal 3 receives the dialog information based on the setting pair name transmitted by the event management apparatus 2. This dialog information includes dialog information for “Setting of terminal paring”.

Next, the display control unit 34 of the communication terminal 3 controls the display 306 to display a “Setting of terminal paring” dialog 3204, which is described below, on the display screen 3101. Then, the operation receiving unit 32 receives selection of the “Setting of terminal pairing” button 3303 by the participant (step S35).

Example of Screen Display:

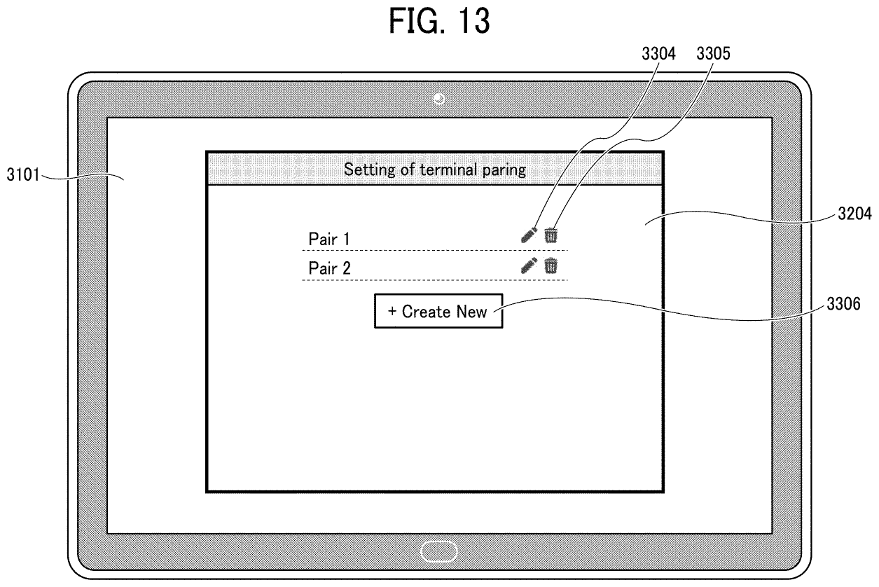

FIG. 13 illustrates an example of a screen display of a dialog for newly creating a terminal pairing. As illustrated in FIG. 13, the display control unit 34 of the communication terminal 3 controls the display 306 to display the “Setting of terminal paring” dialog 3204 on the display screen 3101. In the “Setting of terminal paring” dialog 3204, an add button 3304 and a delete button 3305 are displayed for each of pairing names that are set. Further, in the “Setting of terminal paring” dialog 3204, “+Create New” button 3306 is displayed. The participant operates these buttons as needed to cause a screen currently being displayed to transition to a different screen.

Referring again to FIG. 9, the transmission/reception unit 31 of the communication terminal 3 transmits operation content information set by the participant to the event management apparatus 2 (step S36). Thus, the transmission/reception unit 21 of the event management apparatus 2 receives the operation content information transmitted by the communication terminal 3. This operation content information includes information indicating that the “+Create New” button 3306 illustrated in FIG. 13 is selected.

In response to receiving the information indicating that the “+Create New” button 3306 is selected, the storing/reading unit 29 of the event management apparatus 2 reads newly-creation screen information (step S37). Specifically, the storing/reading unit 29 reads the newly-creation screen information stored and managed in a predetermined area in the storage unit 2000.

Subsequently, the transmission/reception unit 21 transmits dialog information for configuring a new creation screen represented by the read newly-creation screen information to the communication terminal 3 (step S38). Thus, the transmission/reception unit 31 of the communication terminal 3 receives the dialog information for configuring the new creation screen transmitted by the event management apparatus 2. This dialog information includes dialog information for setting a terminal pairing and information on a name of the terminal used in the past that is retrieved in step S23.

Operation of Selecting Communication Terminal for which Terminal Paring is to be Performed:

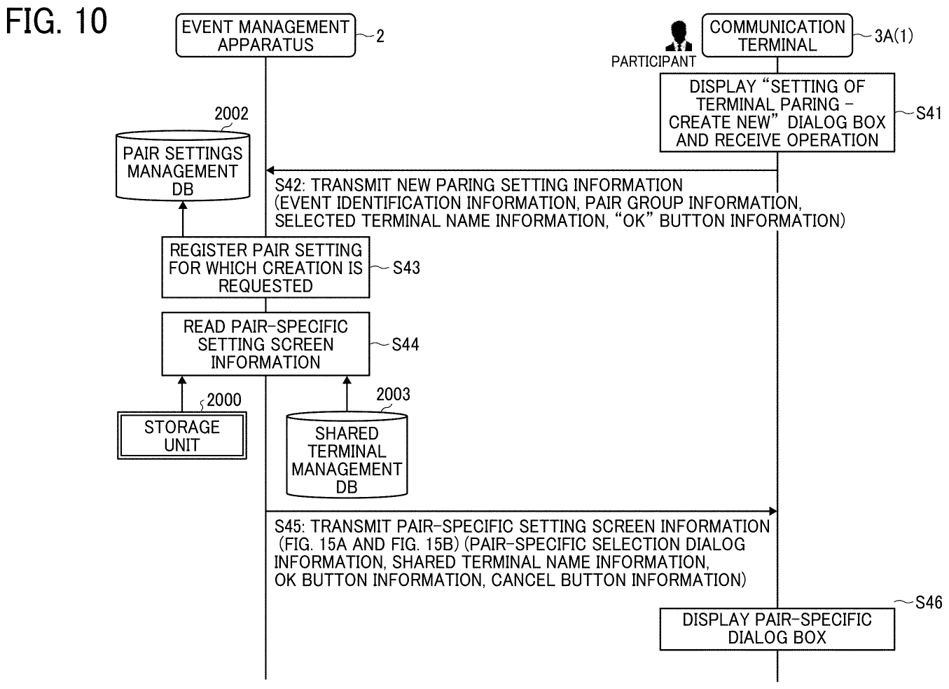

FIG. 10 is a sequence diagram illustrating an example of operation of selecting a communication terminal for which the terminal paring is to be performed. As illustrated in FIG. 10, the display control unit 34 of the communication terminal 3 controls the display 306 to display a “Setting of terminal paring—Create new” dialog 3205, which is described below, on the display screen 3101. Then, the operation receiving unit 32 receives and operation on “Setting of terminal paring—Create new” dialog 3205 by the participant (step S41).

Example of Screen Display:

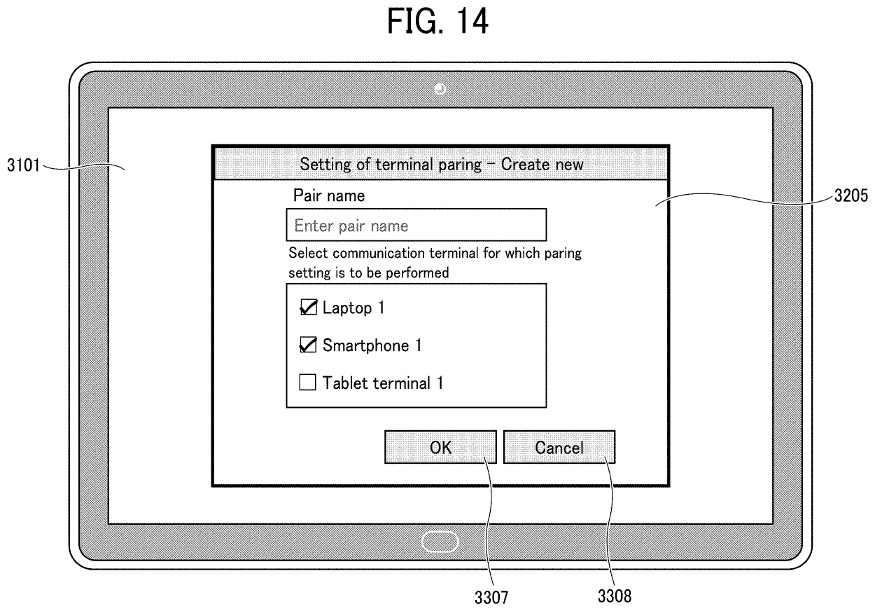

FIG. 14 illustrates an example of a screen display of a dialog for selecting a pair name and a communication terminal for which a terminal paring setting is to be configured. As illustrated in FIG. 14, the display control unit 34 of the communication terminal 3 controls the display 306 to display the “Setting of terminal paring—Create new” dialog 3205 on the display screen 3101. In the “Setting of terminal paring—Create new” dialog 3205, a pair name input area and check boxes are displayed. In the pair name are, a pair name can be input. The check boxes respectively correspond to the communication terminals and allow the participant to select desired terminals for which the paring setting is to be performed. Further, in the “Setting of terminal paring—Create new” dialog 3205, an “OK” button 3307 and a “Cancel” button 3308 are displayed. The “OK” button 3307 and the “Cancel” button 3308 are selectable after the input of the pair name and check marks to the check boxes. The participant operates these buttons as needed to cause a screen currently being displayed to transition to a different screen.

Referring again to FIG. 10, the transmission/reception unit 31 transmits new pairing setting information to the event management apparatus 2 (step S42). Thus, the transmission/reception unit 21 of the event management apparatus 2 receives the new pairing setting transmitted by the communication terminal 3. This new pairing settings information includes the event identification information, pair name information indicating the setting pair name, a selected terminal name information indicating a terminal name, and OK button information corresponding to an operation on the “OK” button 3307. Note that the event identification information transmitted from the communication terminal 3 to the event management apparatus 2 is not limited to the process of step S42 described above.

In response to receiving the new paring settings information, the storing/reading unit 29 of the event management apparatus 2 stores and registers the received pair name information and the selected terminal name information in the pair settings management DB 2002 (see FIG. 5B) (step S43).

Subsequently, the storing/reading unit 29 searches a DB that combines the participant management DB 2004 and the shared terminal management DB 2003 (see FIG. 5C) as the participant identification information as a combination key, using the event identification information received in step S42 as a search key, to read the terminal name and the shared terminal associated with the search key. Further, the storing/reading unit 29 reads pair-specific setting screen information stored and managed in a predetermined area in the storage unit 2000 (step S44). This pair-specific setting screen information includes dialog information, shared terminal name information indicating a shared terminal name, OK button information, and cancel button information.

Subsequently, the transmission/reception unit 21 transmits dialog information based on the read pair-specific setting screen information to the communication terminal 3 (step S45). Thus, the transmission/reception unit 31 of the communication terminal 3 receives the dialog information based on the pair-specific setting screen information transmitted by the event management apparatus 2. This dialog information includes dialog information for displaying the communication terminals selected for each pair, shared terminal information, OK button information indicating an “OK” button, and cancel button information indicating a “cancel” button.

Subsequently, the display control unit 34 of the communication terminal 3 controls the display 306 to display a “pair-specific” dialog 3206 or a “pair-specific” dialog 3027, which is described below, on a display screen 3111 (step S46).

Example of Screen Display:

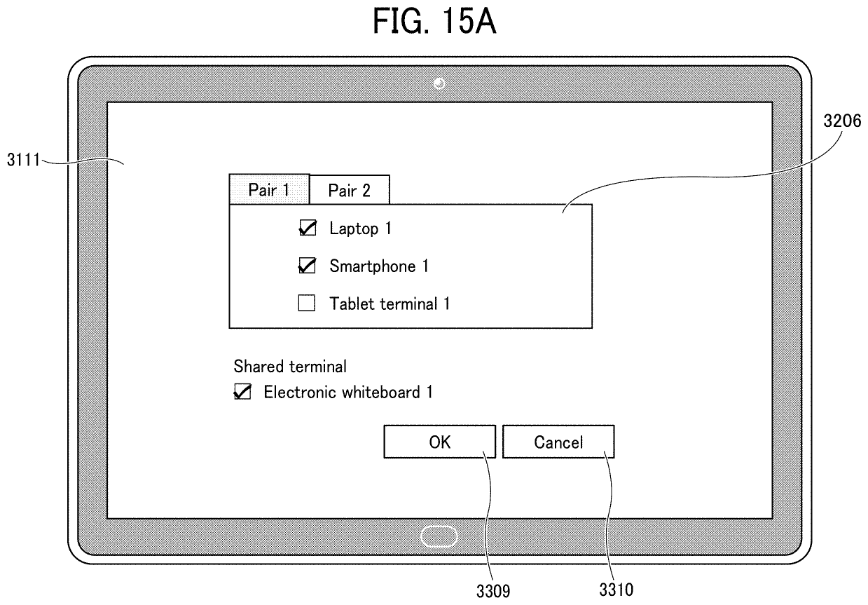

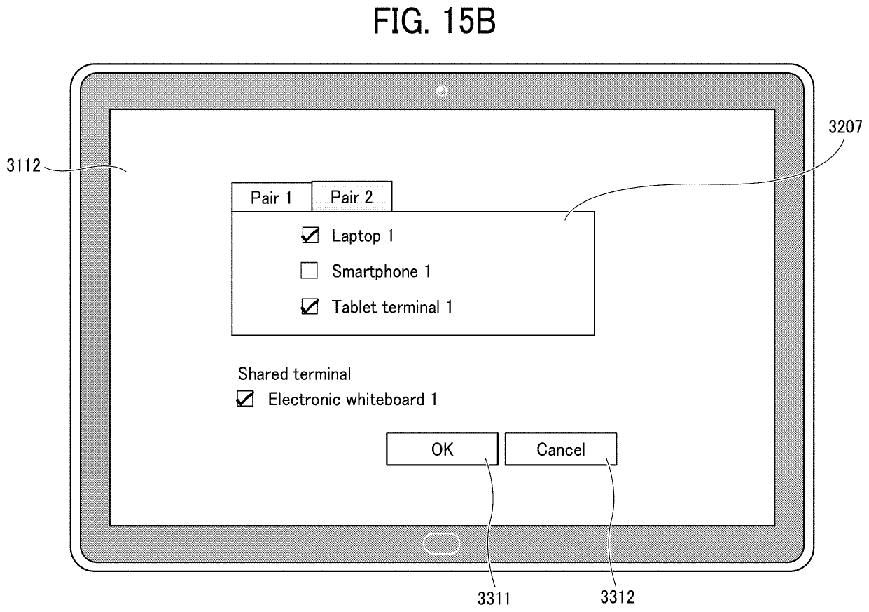

FIG. 15A illustrates an example of a screen display of a dialog for setting terminal pairing including a shared terminal. As illustrated in FIG. 15A, the display control unit 34 of the communication terminal 3 controls the display 306 to display, on the display screen 3111, the “pair-specific” dialog 3206 including a pair name as a tab. In this “pair-specific” dialog 3206, the terminal names set as a pair indicated by the pair name are displayed together with check boxes in which check marks are put. FIG. 15A illustrates an example in which Laptop 1 and Smartphone 1 are selected as Pair 1. Further, on the display screen 3111, Electronic whiteboard 1 indicating the shared terminal 4 is displayed by the display control unit 34 together with a check box in which a check mark is put. Further, on the display screen 3111, an “OK” button 3309 and a “Cancel” button 3310 are displayed by the display control unit 34. The participant presses the “OK” button 3309 and the “Cancel” button 3310 as needed to cause a screen currently being displayed to transition to a different screen.

Example of Screen Display:

FIG. 15B illustrates an example of a screen display of another dialog for setting terminal pairing including a shared terminal. As illustrated in FIG. 15B, the display control unit 34 of the communication terminal 3 controls the display 306 to display, on a display screen 3112, the “pair-specific” dialog 3207 including a pair name as a tab. In this “pair-specific” dialog 3207, the terminal names set as a pair indicated by the pair name are displayed together with check boxes in which check marks are put. FIG. 15B illustrates an example in which Laptop 1 and Table terminal 1 are selected as Pair 2. Further, on the display screen 3112, Electronic whiteboard 1 indicating the shared terminal 4 is displayed by the display control unit 34 together with a check box in which a check mark is put. Further, on the display screen 3112, an “OK” button 3311 and a “Cancel” button 3312 are displayed by the display control unit 34. The participant presses the “OK” button 3311 and the “Cancel” button 3312 as needed to cause a screen currently being displayed to transition to a different screen.

Event Start Request:

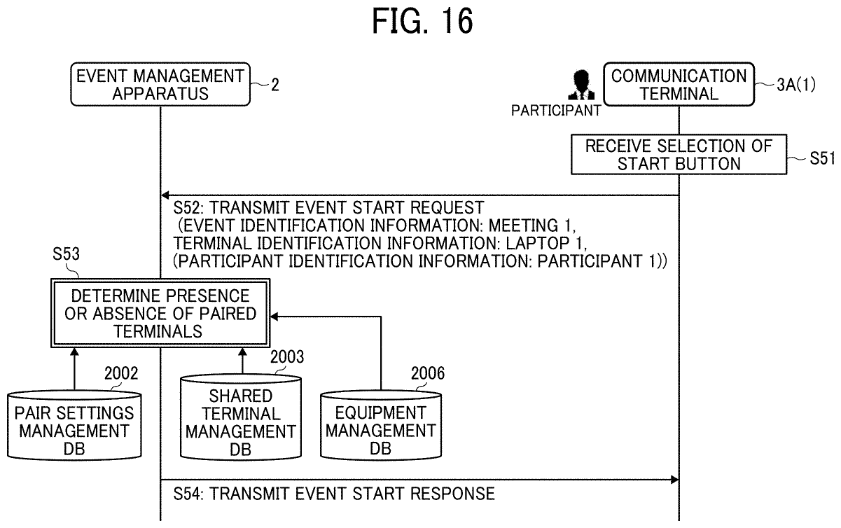

FIG. 16 is a sequence diagram illustrating an example of operation of starting an event, according to the first embodiment. As illustrated in FIG. 16, the operation receiving unit 32 of the communication terminal 3 (communication terminal 3A(1)) receives selection of a start button for starting a particular event (“Meeting 1”) by a participant (step S51). This start button is, for example, the “Join Now” button 3301 displayed on the “UI framework review dialog” 3202 illustrated in FIG. 11. The selection of the “Join Now” button 3301 is an example of an operation for participating in an event. Further, in this case, the communication terminal 3 (communication terminal 3A(1)) is an example of one communication terminal among multiple communication terminals.

After receiving the selection of the start button, the transmission/reception unit 31 of the communication terminal 3 (communication terminal 3A(1)) transmits an event start request for starting “Meeting 1”, which is an example of an event, to the event management apparatus 2 (step S52). Thus, the transmission/reception unit 21 of the event management apparatus 2 receives the event start request for starting the “Meeting 1” transmitted by the communication terminal 3. This event start request includes the event identification information indicated by Meeting 1 and the terminal identification information of Laptop 1.

After receiving the event start request, the determination unit 25 searches the pair settings management DB 2002 (see FIG. 5B), the shared terminal management DB 2003 (see FIG. 5C), and the equipment management DB 2006 (see FIG. 5F) to determine whether any paired terminal is present (step S53).

After the determination whether any paired terminal is present, the transmission/reception unit 21 transmits an event start response to the event start request to the communication terminal 3 (step S54). Thus, the transmission/reception unit 31 of the communication terminal 3 receives the event start response transmitted by the event management apparatus 2.

Operation of Determining Presence of Paired Terminals:

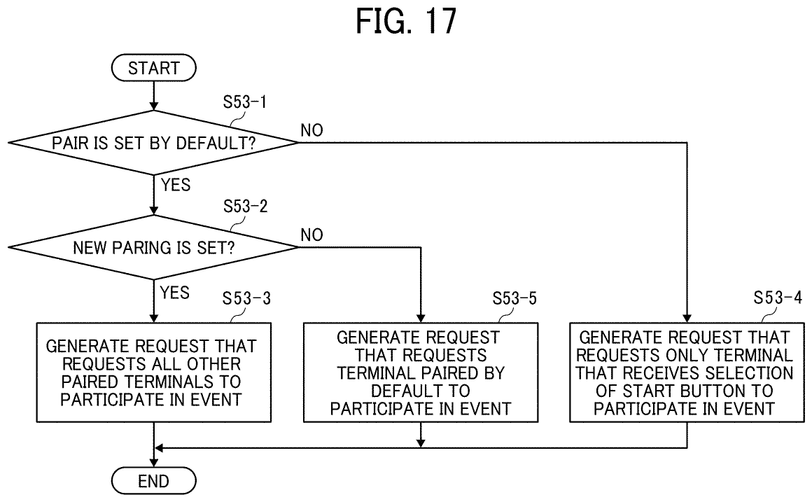

FIG. 17 is a flowchart illustrating an example of operation of whether any paired terminal is present, according to the first embodiment. First, the storing/reading unit 29 searches the pair settings management DB 2002 (see FIG. 5B) using the received terminal identification information as a search key, to read the pair name associated with the search key in the field of the default settings. Then, the determination unit 25 determines whether a pair is set by default (step S53-1).

Based on the determination that a pair is set by default, that is, when a pair of default setting exists (step S53-1: YES), the determination unit 25 determines whether any communication terminal for which the paring setting is newly performed is present (step S53-2).

By contrast, based on the determination that no pair is set by default (step S53-1: NO), the generation unit 27 generates an event participation request for causing only the communication terminal that receives the selection of the start button in step S51 to participate in the target event (step S53-4). Then, the operation ends.

When the determination unit 25 determines that there is a communication terminal for which the pairing has been newly set (step S53-2: YES), the operation proceeds to a process of step S53-3. By contrast, when there is no communication terminal for which pairing has been newly set (step S53-2: NO), the generation unit 27 generates an event participation request for causing the paired terminal set by default to participate in the target event (step S53-5). Then, the operation ends.

Based on the determination that there is a communication terminal for which pairing has been newly set, the storing/reading unit 29 searches the pair settings management DB 2002 (see FIG. 5B) again using the received terminal identification information as a search key, to reading the setting pair name associated with the search key. Then, the generation unit 27 generates an event participation request for causing all the communication terminals indicated by the read pair name to participate in the target event (step S53-3). Then, the operation ends.

Operation of Requesting Other Communication Terminal to Participate in Event:

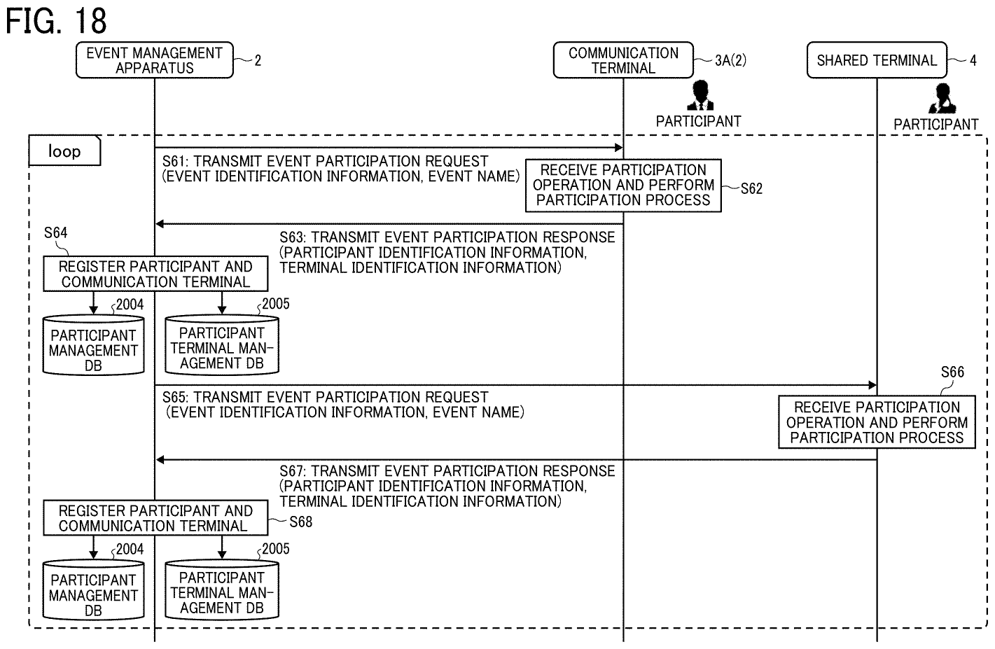

FIG. 18 is a sequence diagram illustrating an example of operation of participating in an event, according to the first embodiment. As illustrated in FIG. 18, the transmission/reception unit 21 of the event management apparatus 2 transmits an event participation request for “Meeting 1” to the communication terminal 3A(2), which is associated with “Meeting 1” and for which the paring setting is performed with respect to the communication terminal 3A(1) (step S61). “Meeting 1” is an example of an event. Thus, the transmission/reception unit 31(2) of the communication terminal 3A(2), that is, Smartphone 1 receives the event participation request for the target event transmitted by the event management apparatus 2. This event participation request includes the event identification information and information of “Meeting 1”, which is an event name. The communication terminal 3A(1) is a communication terminal that receives the selection of the “Join Now” button 3301 for “Meeting 1”, as described referring to step S51. In this case, the communication terminal 3 (communication terminal 3A(2)) is an example of another communication terminal among multiple communication terminals.

The operation receiving unit 32(2) of Smartphone 1 that receives the event participation request receives an operation for participating in the event by the participant. Further, the execution unit 38(2) performs a process of participating in the target event (step S62).

After the execution unit 38(2) executes the participation process, the transmission/reception unit 31(2) transmits an event participation response to the event management apparatus 2 (step S63). Thus, the transmission/reception unit 21 of the event management apparatus 2 receives the event participation response transmitted by the communication terminal 3. This event participation response includes the participant identification information and the terminal identification information.

The storing/reading unit 29 of the event management apparatus 2 that receives the event participation response performs a process of registering the participant and the communication terminal (step S64). Specifically, the storing/reading unit 29 cooperates with the management unit 28 to set the participation status associated with the participant's name indicated by the participant identification information to “participating” in the participant management DB 2004 (see FIG. 5D). Further, the storing/reading unit 29 cooperates with the management unit 28 to set the participating terminal name (Smartphone 1) associated with the terminal identification information to the terminal name of the communication terminal in the participating terminal management DB 2005 (see FIG. 5E).

Subsequently, the transmission/reception unit 21 transmits, to the shared terminal 4 (Electronic whiteboard 1), an event participation request requesting participation in the target event (“Meeting 1”) (step S65). Thus, the transmission/reception unit 41 of the shared terminal 4 receives the event participation request for the target event transmitted by the event management apparatus 2. This event participation request includes the event identification information and information of “Meeting 1”, which is an event name. In this case, the shared terminal 4 is another example of another communication terminal among multiple communication terminals. In the process of step S61 and step S65 described above, Laptop 1, which is an example of the communication terminal 3A(1), Smartphone 1, which is an example of communication terminal 3A(2), and Electronic whiteboard 1, which is an example of shared terminal 4 are communication terminals associated with “Meeting 1”, which is an example of an event, and “Meeting room 1”, which is an example of a resource at which “Meeting 1” is held.

The operation receiving unit 42 of the shared terminal 4 that receives the event participation request receives an operation for participating in the event by a host (or a participant who participates in the same “Meeting 1”). Further, the execution unit 48 performs a process of participating in the target event (step S66).

After the execution unit 48 executes the participation process, the transmission/reception unit 41 transmits a participation response to the event management apparatus 2 (step S67). Thus, the transmission/reception unit 21 of the event management apparatus 2 receives the participation response transmitted by the shared terminal 4. This participation response includes the participant identification information and the terminal identification information.

The storing/reading unit 29 of the event management apparatus 2 that receives the event participation response performs a process of registering the participant and the communication terminal (step S68). Specifically, the storing/reading unit 29 cooperates with the management unit 28 to set the participation status associated with the participant's name indicated by the participant identification information to “participating” in the participant management DB 2004 (see FIG. 5D). Further, the storing/reading unit 29 cooperates with the management unit 28 to set the participating terminal name (Electronic whiteboard 1) associated with the terminal identification information to the terminal name of the communication terminal in the participating terminal management DB 2005 (see FIG. 5E). The processes from step S61 to step S68 are repeatedly performed for all communication terminals to which the event participation request is to be sent.

The above-described operation performed for Pair 1 is performed for the communication terminals for which the paring setting is performed as Pair 2 in substantially the same manner. Further, in one example, Smartphone 1 and Tablet terminal 1 for which the paring setting is performed with Laptop 1 are used by the participant himself/herself who participates in “Meeting 1” held in “Meeting room 1”. In another example, such the Smartphone 1 and Tablet terminal 1 are used by one or more other participants who borrow Smartphone 1 and/or Tablet terminal 1 and participates in “Meeting 1”.

In another example, in the event management system 1 according to the present embodiment, another apparatus intervenes between the event management apparatus 2 and the shared terminal 4 in execution of the processes of steps S65 and S67. In other words, various information (data) transmitted and received between the event management apparatus 2 and the shared terminal 4 may be transmitted and received via another apparatus. The above-described configuration and operation may also be applied to other processing steps between the event management apparatus 2 and the shared terminal 4.

Example of Screen Display:

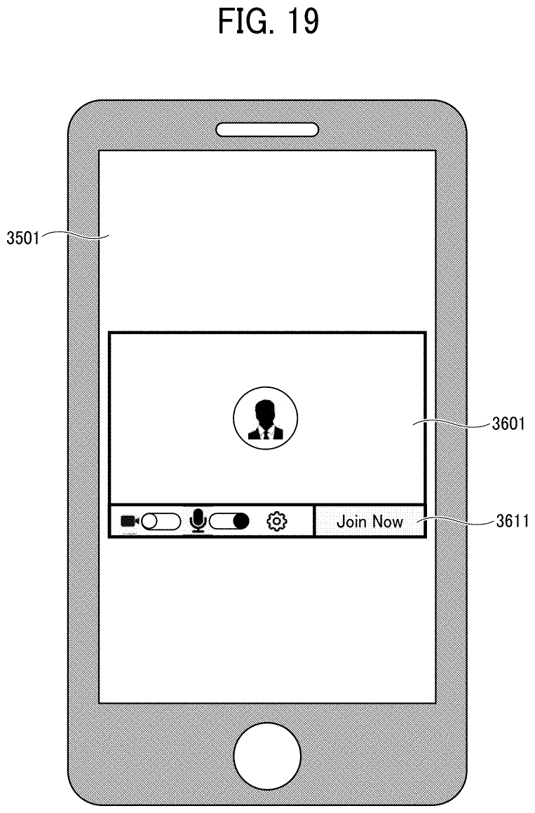

FIG. 19 illustrates an example of a screen of a dialog requesting another communication terminal to participate in an event, according to the first embodiment. As illustrated in FIG. 19, the display control unit 34 controls the display 306 of Smartphone 1 to display an “Event participation” dialog 3601 similar to the “UI framework review dialog” 3202 illustrated in FIG. 11 on a display screen 3501. The smartphone 1 is an example of another communication terminal 3. Further, in the “Event participation” dialog 3601, a “Join Now” button 3611 is displayed by the display control unit 34. The participant selects the “Join Now” button 3611 as needed, to start a process of participating in the target event and to cause this dialog screen to transition to a different screen.

As described above, according to the present embodiment, the event management apparatus 2 receives an event start request for starting “Meeting 1” transmitted by the communication terminal 3A(1) (step S52) that receives selection of the start button. Thereafter, the event management apparatus 2 transmits the event participation request requesting participation in the target event to the communication terminal 3A(2) and the shared terminal 4 that are associated with “Meeting 1” and for which the paring setting is performed with the communication terminal 3A(1) that receives selection of the “Join Now” button 3301 for “Meeting 1” (step S61 and step S65). With this configuration, in a case that a participant participates in an event using multiple communication terminals, the participant performs a start request operation at one communication terminal, to cause one or more other communication terminals that are associated with the event in which the participant participates and the participant to also participate in the event.

### Second Embodiment

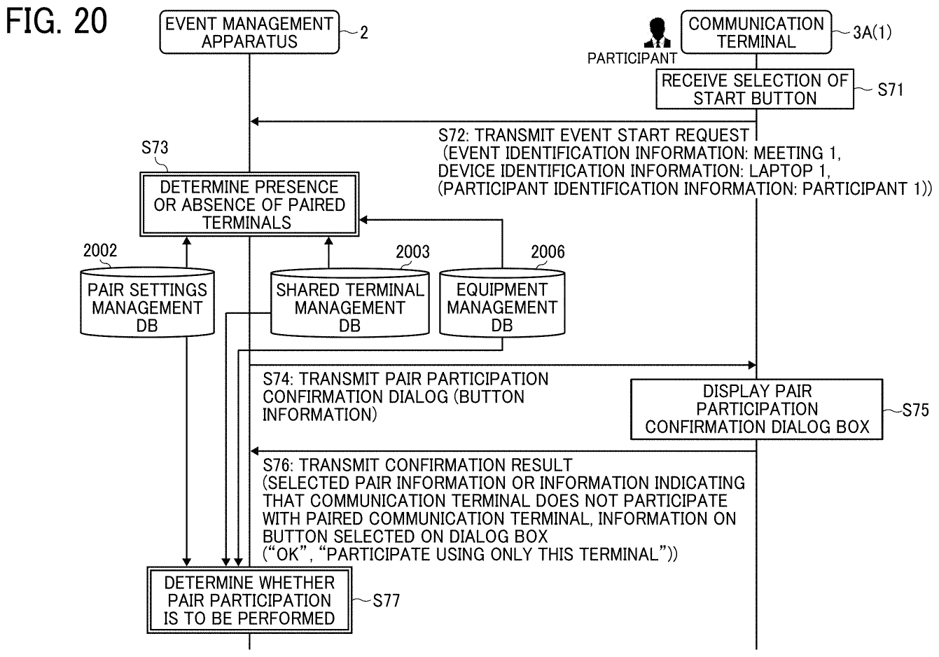

Referring now to FIG. 20 to FIG. 24, a description is given of a second embodiment of the present disclosure. In the second embodiment, a process is added in which when a participant starts an event, the event management apparatus 2 causes the communication terminal 3 to display a pair participation confirmation dialog to prompt a participant to select the pair participation. Since the event management system 1 according to the second embodiment has substantially the same apparatus configuration, hardware configurations, and functional configurations as the event management system 1 according to the first embodiment, redundant descriptions thereof are omitted below.

Event Start Request:

FIG. 20 is a sequence diagram illustrating an example of operation of starting an event, according to the second embodiment. The process of steps S71 and step S72 illustrated in FIG. 20 is performed in substantially the same as the processes of step S51 and step S52 as described above described referring to the sequence diagram of FIG. 16, redundant descriptions thereof are omitted below.

After step S72, the determination unit 25 of the event management apparatus 2 determines whether any paired terminal is present (step S73).

Operation of Determining Presence of Paired Terminals:

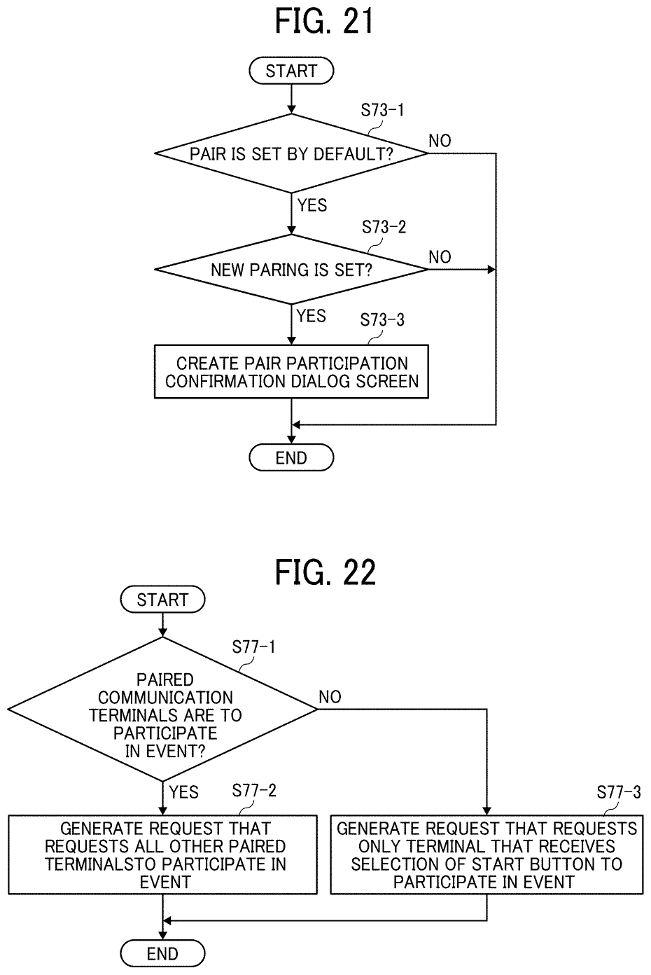

FIG. 21 is a flowchart illustrating an example of operation of whether any paired terminal is present, according to the second embodiment. As illustrated in FIG. 21, the storing/reading unit 29 searches the pair settings management DB 2002 (see FIG. 5B) using the received terminal identification information as a search key, to read the pair name associated with the search key in the field of the default settings. Then, the determination unit 25 determines whether a pair is set by default (step S73-1).

Based on the determination that a pair is set by default, that is, when a pair of default setting exists (step S73-1: YES), the determination unit 25 determines whether any communication terminal for which the paring setting is newly performed is present (step S73-2).

By contrast, when the determination unit 25 determines that the pair of default setting does not exist (step S73-1: NO), the operation ends.

When the determination unit 25 determines that there is a communication terminal for which the pairing has been newly set (step S73-2: YES), the generation unit 27 generates a pair participation confirmation dialog (step S73-3). Then, the operation ends. By contrast, when the determination unit 25 determines there is no communication terminal for which pairing has been newly set (step S73-2: NO), the operation eds.

Referring again to FIG. 20, after the determination of whether any paired terminal is present, the transmission/reception unit 21 transmits pair participation confirmation dialog information including button information to the communication terminal 3 (step S74). Thus, the transmission/reception unit 31 of the communication terminal 3 receives the pair participation confirmation dialog information transmitted by the event management apparatus 2.

The display control unit 34 of the communication terminal 3 that receives the pair participation confirmation dialog information controls the display 306 to displays a “pair participation confirmation dialog” 3208, which is described below, on the display screen 3101 (step S75).

Example of Screen Display:

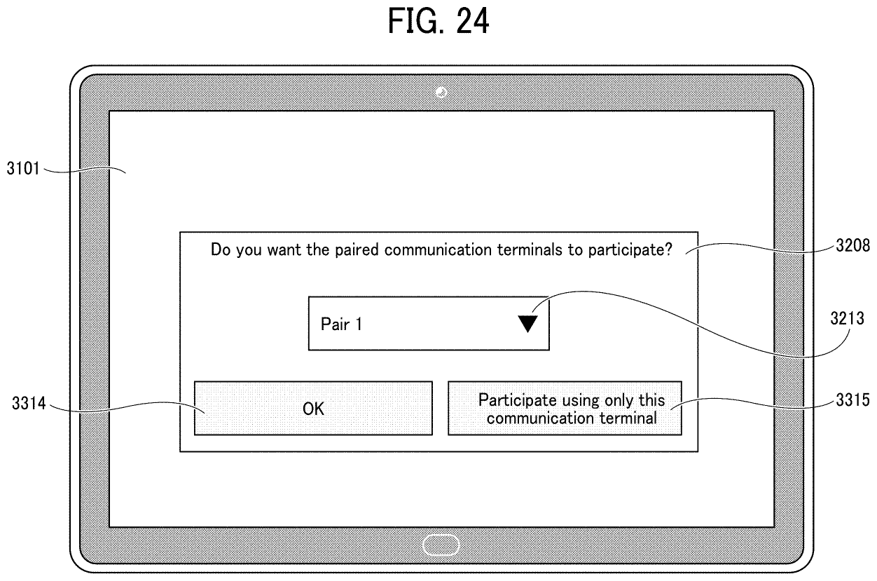

FIG. 24 illustrates an example of a screen display of the pair participation confirmation dialog, according to the second embodiment. As illustrated in FIG. 24, the display control unit 34 of the communication terminal 3 controls the display 306 to display the “pair participation confirmation dialog” 3208 on the display screen 3101. Further, in the “pair participation confirmation dialog” 3208, a “pair name selection” display section 3213 that allows the participant to select a desired pair name from a drop-down list is displayed by the display control unit 34. Further, in the “pair participation confirmation dialog” 3208, an “OK” button 3314 and a “Participate using only this communication terminal” button 3315 are displayed by the display control unit 34. The “Participate using only this communication terminal” button 3315 is a button that allows the participant to confirm whether the paired communication terminal with the pair name selected in the “pair name selection” display section 3213 is to participate in the target event. In the present embodiment, the “pair participation confirmation” dialog 3208 functions as an example of combination participation confirmation means or a graphical representation for inquiring the participant whether to accept a combination that is set by associating the one communication terminal with the another communication terminal to participate in the event.

Referring again to FIG. 20, after the display control unit 34 displays the “pair participation confirmation dialog” 3208, the transmission/reception unit 31 transmits a confirmation result to the event management apparatus 2 (step S76). Thus, the transmission/reception unit 21 of the event management apparatus 2 receives the confirmation result transmitted by the communication terminal 3. This confirmation result includes either one of the selected pair information and information indicating that pair participation is not to be performed, and either one of “OK” button information and “Participate using only this communication terminal” button information selected on the dialog.

Subsequently, the determination unit 25 of the event management apparatus 2 determines whether pair participation is to be performed (step S77).

Operation of Determining whether Pair Participation is to be Performed:

FIG. 22 is a flowchart illustrating an example of operation of determining whether pair participation is to be performed, according to the second embodiment. First, the determination unit 25 determines whether the paired communication terminals are to participate, based on the received button information (step S77-1). When the paired communication terminals are to be participate, that is, when the “OK” button 3314 is selected (step S77-1: YES), the generation unit 27 generates an event participation request requesting all the communication terminals indicated by the read pair name to participated in the target event (step S77-2). Then, the operation ends.

By contrast, when the paired communication terminals are not to participate, that is, when the “Participate using only this communication terminal” button 3315 is selected (step S77-1: NO), the generation unit 27 generates an event participation request requesting only the communication terminal that receives the start button in step S71 to participate in the target event (step S77-3). Then, the operation ends. The processes from step S81 to step S88 are repeatedly performed for all communication terminals to which the event participation request is to be sent.

Event Start Sequence:

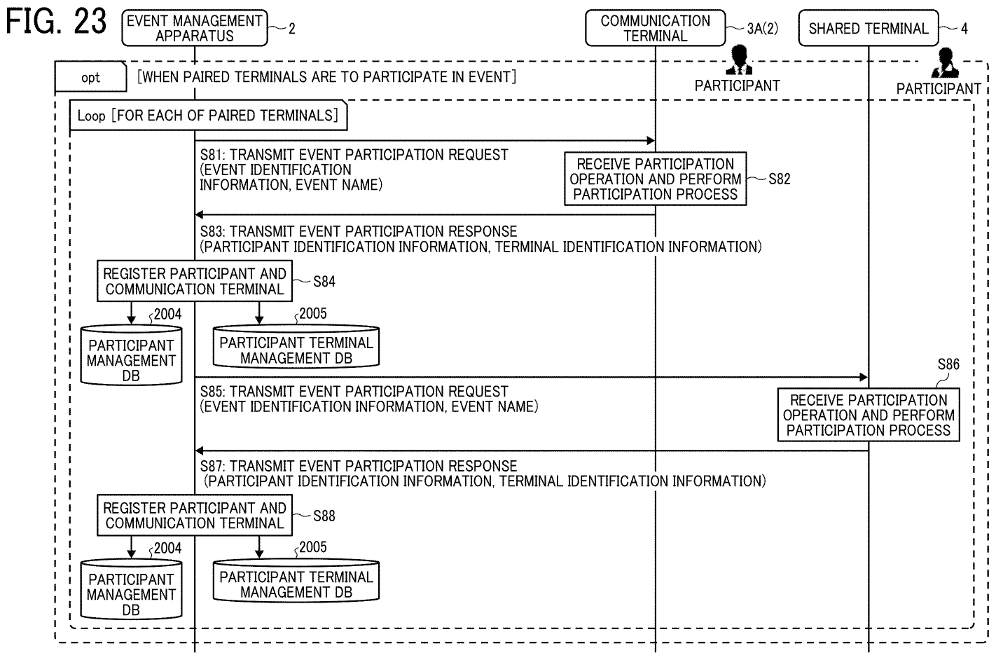

FIG. 23 is a sequence diagram illustrating an example of operation of participating in an event, according to the second embodiment. As illustrated in FIG. 23, the event management apparatus 2 performs the following processes for all the paired terminals when paring participation is to be performed. Processes in the sequence diagram of FIG. 23 are substantially the same as the processes in the sequence diagram of FIG. 18.

First, the transmission/reception unit 21 of the event management apparatus 2 transmits an event participation request requesting participation in the target event to the communication terminal 3A(2), which is associated with “Meeting 1” and for which the paring setting is performed with the communication terminal 3A(1) that receives selection of the “Join Now” button 3301 for the event “Meeting 1” (step S81). Thus, the transmission/reception unit 31(2) of the communication terminal 3A(2), that is, Smartphone 1 receives the event participation request for the target event transmitted by the event management apparatus 2. This event participation request includes the event identification information and information of “Meeting 1”, which is an event name. The communication terminal 3A(1) is a communication terminal that receives the selection of the “Join Now” button 3301 for “Meeting 1”, as described referring to step S81. In this case, the communication terminal 3 (communication terminal 3A(2)) is an example of another communication terminal among multiple communication terminals.

The operation receiving unit 32(2) of Smartphone 1 that receives the event participation request receives an operation for participating in the event by the participant. Further, the execution unit 38(2) performs a process of participating in the target event (step S82).

After the execution unit 38(2) executes the participation process, the transmission/reception unit 31(2) transmits an event participation response to the event management apparatus 2 (step S83). Thus, the transmission/reception unit 21 of the event management apparatus 2 receives the event participation response transmitted by the communication terminal 3(2). This event participation response includes the participant identification information and the terminal identification information.

The storing/reading unit 29 of the event management apparatus 2 that receives the event participation response performs a process of registering the participant and the communication terminal (step S84). Specifically, the storing/reading unit 29 cooperates with the management unit 28 to set the participation status associated with the participant's name indicated by the participant identification information to “participating” in the participant management DB 2004 (see FIG. 5D). Further, the storing/reading unit 29 cooperates with the management unit 28 to set the participating terminal name (Smartphone 1) associated with the terminal identification information to the terminal name of the communication terminal in the participating terminal management DB 2005 (see FIG. 5E).

Subsequently, the transmission/reception unit 21 transmits, to the shared terminal 4 (Electronic whiteboard 1), an event participation request requesting participation in the target event (“Meeting 1”) (step S85). Thus, the transmission/reception unit 41 of the shared terminal 4 receives the event participation request for the target event transmitted by the event management apparatus 2. This event participation request includes the event identification information and information of “Meeting 1”, which is an event name. In this case, the shared terminal 4 is another example of another communication terminal among multiple communication terminals. In the process of step S81 and step S85 described above, Laptop 1, which is an example of the communication terminal 3A(1), Smartphone 1, which is an example of communication terminal 3A(2), and Electronic whiteboard 1, which is an example of shared terminal 4 are communication terminals associated with “Meeting 1”, which is an example of an event, and “Meeting room 1”, which is an example of a resource at which “Meeting 1” is held.

The operation receiving unit 42 of the shared terminal 4 that receives the event participation request receives an operation for participating in the event by a host (or a participant who participates in the same “Meeting 1”). Further, the execution unit 48 performs a process of participating in the target event (step S86).

After the execution unit 48 executes the participation process, the transmission/reception unit 41 transmits an event participation response to the event management apparatus 2 (step S87). Thus, the transmission/reception unit 21 of the event management apparatus 2 receives the event participation response transmitted by the shared terminal 4. This participation response includes the participant identification information and the terminal identification information.

The storing/reading unit 29 of the event management apparatus 2 that receives the event participation response performs a process of registering the participant and the communication terminal (step S88). Specifically, the storing/reading unit 29 cooperates with the management unit 28 to set the participation status associated with the participant's name indicated by the participant identification information to “participating” in the participant management DB 2004 (see FIG. 5D). Further, the storing/reading unit 29 cooperates with the management unit 28 to set the participating terminal name (Electronic whiteboard 1) associated with the terminal identification information to the terminal name of the communication terminal in the participating terminal management DB 2005 (see FIG. 5E). The processes from step S81 to step S88 are repeatedly performed for all communication terminals to which the event participation request is to be sent.

The above-described operation performed for Pair 1 is performed for the communication terminals for which the paring setting is performed as Pair 2 in substantially the same manner. Further, in one example, Smartphone 1 and Tablet terminal 1 for which the paring setting is performed with Laptop 1 are used by the participant himself/herself who participates in “Meeting 1” held in “Meeting room 1”. In another example, such the Smartphone 1 and Tablet terminal 1 are used by one or more other participants who borrow Smartphone 1 and/or Tablet terminal 1 and participates in “Meeting 1”.

As described above, according to the present embodiment, the event management apparatus 2 receives an event start request for starting “Meeting 1” transmitted by the communication terminal 3A(1) (step S72) that receives selection of the start button. After receiving the event start request, the event management apparatus 2 transmits the pair participation confirmation dialog information including the button information to the communication terminal 3, as described above referring to step S74. This configuration allows the event management system 1 according to the present embodiment to prompt the participant to confirm whether another communication terminal paired with the communication terminal 3 is to participate in an event, in addition to the effect produced by the first embodiment.

### Variation of Second Embodiment

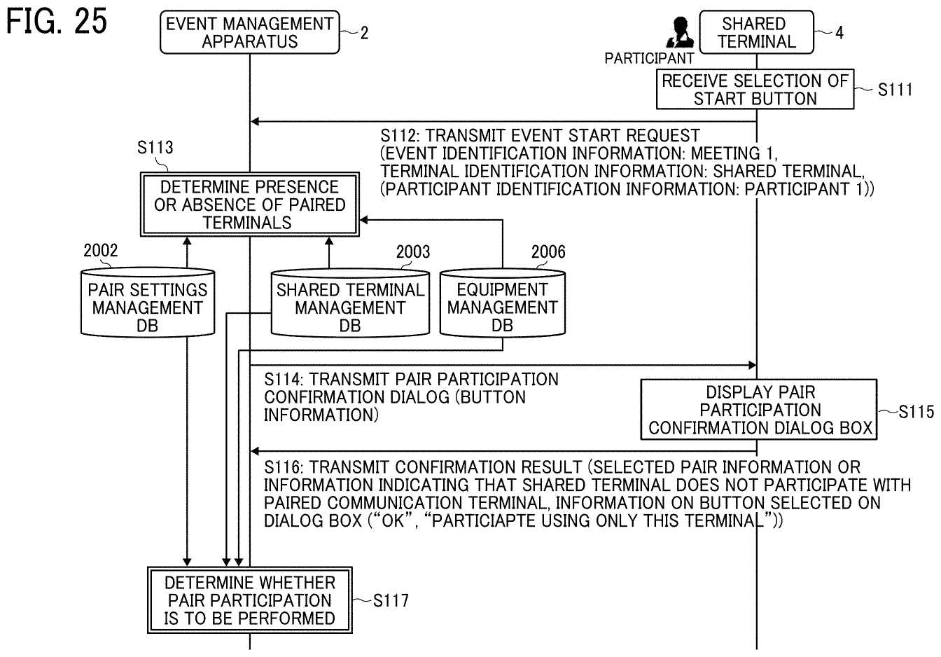

Referring now to FIG. 25 to FIG. 27, a description is given of a variation of the second embodiment of the present disclosure. In the variation of the second embodiment, when a participant starts an event, the shared terminal 4 used in the event performs operation of starting the event to the event management apparatus 2. Since the event management system 1 according to the variation of the second embodiment has substantially the same apparatus configuration, hardware configurations, and functional configurations as the event management system 1 according to the second embodiment, redundant descriptions thereof are omitted below.

Event Start Request from Electronic Whiteboard:

FIG. 25 is a sequence diagram illustrating an example of operation of starting an event, according to the variation of the second embodiment. As illustrated in FIG. 25, the operation receiving unit 42 of the shared terminal 4 (Electronic whiteboard 1) receives selection of a start button by a participant or a host of “Meeting 1”, which is an example of an event (step S111). This start button is, for example, any button that Electronic whiteboard 1 includes. Any suitable item such as a button, a graphical representation, or a key having capability of starting an event will suffice. In this case, the shared terminal 4 is another example of one communication terminal among multiple communication terminals.

After receiving the selection of the start button, the transmission/reception unit 41 of the shared terminal 4 transmits an event start request to the event management apparatus 2 (step S112). Thus, the transmission/reception unit 21 of the event management apparatus 2 receives the event start request transmitted by the shared terminal 4. This event start request includes the event identification information indicated by “Meeting 1” and the terminal identification information of the shared terminal 4.

Subsequently, the determination unit 25 of the event management apparatus 2 determines whether any paired terminal is present (step S113). Since the operation of determining whether any paired terminal is present in step S113 is performed in substantially the same manner as described above referring to step S73, a detailed description thereof is omitted below.

After the determination of whether any paired terminal is present, the transmission/reception unit 21 transmits pair participation confirmation dialog information including button information to the shared terminal 4 (step S114). Thus, the transmission/reception unit 41 of the shared terminal 4 receives the pair participation confirmation dialog information transmitted by the event management apparatus 2.

The display control unit 44 of the shared terminal 4 that receives the pair participation confirmation dialog information controls the display 420 to displays a “pair participation confirmation dialog” 4201, which is described below, on a display screen 4101 (step S115).

Example of Screen Display:

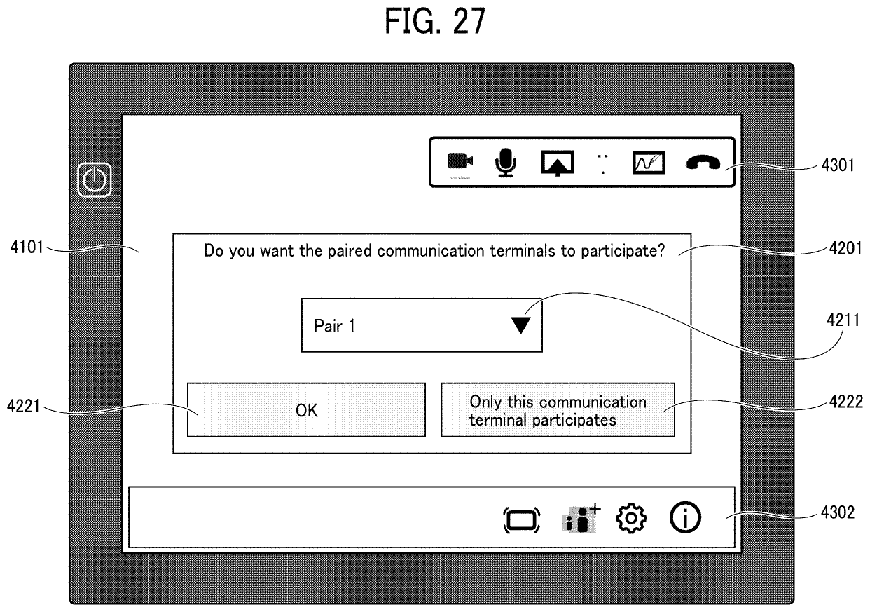

FIG. 27 illustrates an example of a screen display of the pair participation confirmation dialog, according to the variation of the second embodiment. As illustrated in FIG. 27, the display control unit 44 of the shared terminal 4 controls the display 420 to display the “pair participation confirmation dialog” 4201 on the display screen 4101. Further, in the “pair participation confirmation dialog” 4201, a “pair name selection” display section 4211 that allows the participant to select a desired pair name from a drop-down list is displayed by the display control unit 44. Further, in the “pair participation confirmation dialog” 4201, an “OK” button 4221 and a “Participate using only this communication terminal” button 4222 are displayed by the display control unit 44. The “Participate using only this communication terminal” button 4222 is a button that allows the participant to confirm whether the paired communication terminal with the pair name selected in the “pair name selection” display section 4211 is to participate in the target event. Further, on the display screen 4101, “various function selection buttons” 4301 and “various setting buttons” 4302 are displayed by the display control unit 44. The “various function selection buttons” 4301 allows the participant to select a desired function such as a video camera function, a microphone function, or an event exit function. The “various setting buttons” 4302 allows the participant to configure settings such as addition and/or setting of participants.

Referring again to FIG. 25, after the display control unit 44 displays the “pair participation confirmation dialog” 4201, the transmission/reception unit 41 transmits a confirmation result to the event management apparatus 2 (step S116). Thus, the transmission/reception unit 21 of the event management apparatus 2 receives the confirmation result transmitted by the shared terminal 4. This confirmation result includes either one of the selected pair information and information indicating that pair participation is not to be performed, and either one of “OK” button information and “Participate using only this communication terminal” button information selected on the dialog.

Subsequently, the determination unit 25 of the event management apparatus 2 determines whether pair participation is to be performed (step S117). Since the operation of determining whether pair participation is to be performed is performed in substantially the same manner as described above referring to step S77, and a redundant description is omitted below.

Event Start Sequence:

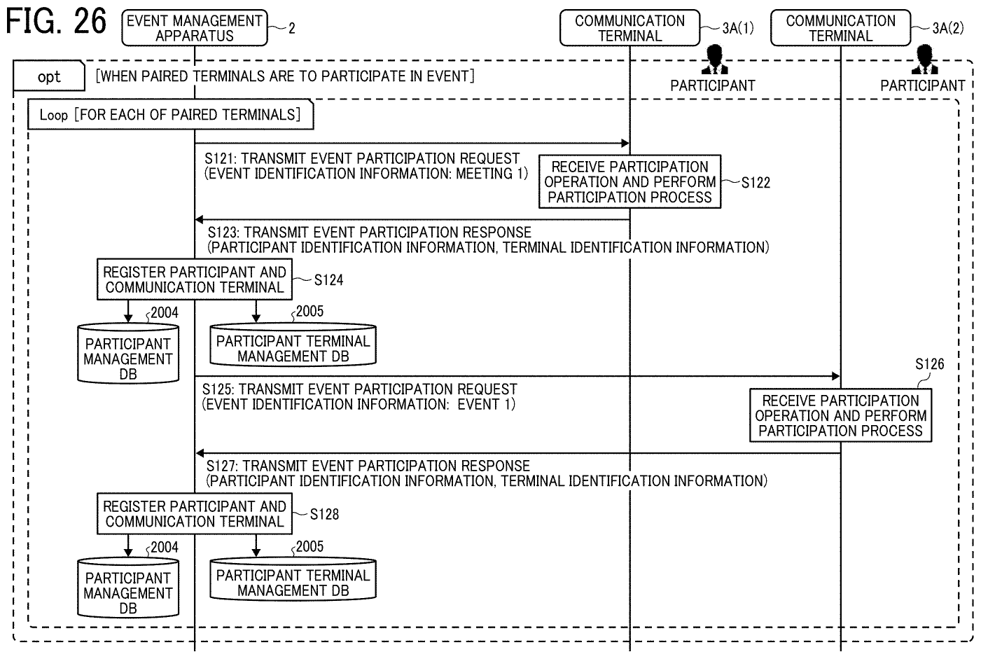

FIG. 26 is a sequence diagram illustrating an example of operation of participating an event, according to the variation of the second embodiment. As illustrated in FIG. 26, the event management apparatus 2 performs the following processes for all the paired terminals when paring participation is to be performed. Processes in the sequence diagram of FIG. 26 are substantially the same as the processes in the sequence diagram of FIG. 23.

First, the transmission/reception unit 21 of the event management apparatus 2 transmits an event participation request requesting participation in the target event to the communication terminal 3A(1), which is associated with “Meeting 1” and for which the paring setting is performed with the shared terminal 4 that receives selection of the start button for the event “Meeting 1” (step S121). Thus, the transmission/reception unit 31(1) of the communication terminal 3A(1), that is, Laptop 1 receives the event participation request for the target event transmitted by the event management apparatus 2. This event participation request includes the event identification information and information of “Meeting 1”, which is an event name. The shared terminal 4 is a communication terminal that receives the selection of the start button for “Meeting 1”, as described referring to step S111. In this case, the communication terminal 3 (communication terminal 3A(1)) is an example of another communication terminal among multiple communication terminals.

The operation receiving unit 32(1) of Laptop 1 that receives the event participation request receives an operation for participating in the event by the participant. Further, the execution unit 38(1) performs a process of participating in the target event (step S122).

After the execution unit 38(1) executes the participation process, the transmission/reception unit 31(1) transmits an event participation response to the event management apparatus 2 (step S123). Thus, the transmission/reception unit 21 of the event management apparatus 2 receives the event participation response transmitted by the communication terminal 3(1). This event participation response includes the participant identification information and the terminal identification information.

The storing/reading unit 29 of the event management apparatus 2 that receives the event participation response performs a process of registering the participant and the communication terminal (step S124). Specifically, the storing/reading unit 29 cooperates with the management unit 28 to set the participation status associated with the participant's name indicated by the participant identification information to “participating” in the participant management DB 2004 (see FIG. 5D). Further, the storing/reading unit 29 cooperates with the management unit 28 to set the participating terminal name (Laptop 1) associated with the terminal identification information to the terminal name of the communication terminal in the participating terminal management DB 2005 (see FIG. 5E).

Subsequently, the transmission/reception unit 21 transmits, to the communication terminal 3A(2), which is a communication terminal for which the paring setting is performed, an event participation request requesting participation in the target event (“Meeting 1”) (step S125). Thus, the transmission/reception unit 31(2) of the communication terminal 3A(2) receives the event participation request for the target event transmitted by the event management apparatus 2. This event participation request includes the event identification information and information of “Meeting 1”, which is an event name. In this case, the communication terminal 3 (communication terminal 3A(2)) is another example of another communication terminal among multiple communication terminals. In the process of step S121 and step S125 described above, Laptop 1, which is an example of the communication terminal 3A(1), Smartphone 1, which is an example of communication terminal 3A(2), and Electronic whiteboard 1, which is an example of shared terminal 4 are communication terminals associated with “Meeting 1”, which is an example of an event, and “Meeting room 1”, which is an example of a resource at which “Meeting 1” is held.

The operation receiving unit 32(2) of the communication terminal 3A(2) that receives the event participation request receives an operation for participating in the event by a host (or a participant who participates in the same “Meeting 1”). Further, the execution unit 38(2) performs a process of participating in the target event (step S126).

After the execution unit 38(2) executes the participation process, the transmission/reception unit 31(2) transmits an event participation response to the event management apparatus 2 (step S127). Thus, the transmission/reception unit 21 of the event management apparatus 2 receives the event participation response transmitted by the communication terminal 3(2). This event participation response includes the participant identification information and the terminal identification information.

The storing/reading unit 29 of the event management apparatus 2 that receives the event participation response performs a process of registering the participant and the communication terminal (step S128). Specifically, the storing/reading unit 29 cooperates with the management unit 28 to set the participation status associated with the participant's name indicated by the participant identification information to “participating” in the participant management DB 2004 (see FIG. 5D). Further, the storing/reading unit 29 cooperates with the management unit 28 to set the participating terminal name (Smartphone 1) associated with the terminal identification information to the terminal name of the communication terminal in the participating terminal management DB 2005 (see FIG. 5E). The processes from step S121 to step S128 are repeatedly performed for all communication terminals to which the event participation request is to be sent.

The above-described operation performed for Pair 1 is performed for the communication terminals for which the paring setting is performed as Pair 2 in substantially the same manner. Further, in one example, Laptop 1 and Smartphone 1 for which the paring setting is performed with the shared terminal 4 are used by the participant himself/herself who participates in “Meeting 1” held in “Meeting room 1”. In another example, such the Laptop 1 and Smartphone 1 are used by one or more other participants who borrow Laptop 1 and/or Smartphone 1 and participates in “Meeting 1”.

In Case that Communication Terminal or Shared Terminal has Function of Event Management Apparatus (P2P):

In the present embodiment, a case will be described in which the communication terminal 3 or the shared terminal 4 that participates in an event has functions of the event management apparatus 2. In this case, in the event management system 1, the event management apparatus 2 may be omitted. For example, Peer to Peer (P2P) communication is performed between each communication terminal 3 and the shared terminal 4, and the event participation start process, the event participation response process, and the event participation request process for an event are performed. In this case, the data tables are allocated to either an inviting terminal or an invited terminal. The inviting terminal is a terminal that starts participating in an event. The invited terminal is a terminal that is requested to participate in the event. The inviting terminal manages one or more of the data tables allocated thereto, and the invited terminal manages one or more of the data tables allocated thereto. Further, for example, in a case that one communication terminal alternately operates as the inviting terminal and the invited terminal, a “P2P event management system” may be build. In such the P2P event management system, the one communication terminal accesses, through the communication network 100, a dedicated server that stores and manages the data tables, to download a table to be used as needed.

As described above, according to the present embodiment, the event management apparatus 2 receives information indicating that the start button is selected by the host of “Meeting 1” (step S111), the information being transmitted by Electronic whiteboard 1, which is an example of the shared terminal 4. After receiving the information indicating that the start button is selected, the event management apparatus 2 transmits the pair participation confirmation dialog information including the button information to the shared terminal 4, as described above referring to step S114. This configuration allows the event management system 1 according to the present embodiment to prompt, in response to an operation by a host who holds an event, the participant to confirm whether another communication terminal paired with the shared terminal 4 is to participate in the event, in addition to the effect produced by the first embodiment.

The data tables stored and managed by the event management apparatus 2 are merely examples, and definition of each item, setting condition and setting timing, and exchange of information (data) with each data table are not limited to the contents described above.

According to one or more embodiments, a non-transitory computer-executable medium storing a program storing instructions is provided, which, when executed by a processor of an event management apparatus that manages one communication terminal among multiple communication terminals used in an event in association with the event, causes the event management apparatus to perform a method. The method includes receiving an event start request that requests start of the event, the event start request being transmitted by the one communication terminal. The method includes, in response to the received event start request, transmitting an event participation request that requests participation in the event to another communication terminal among the multiple communication terminals, the another communication terminal being associated with the event and associated with a participant who participates in the event using the one communication terminal.

In the related art, when a participant participates in a certain event using a plurality of communication terminals, the participant needs to perform activation operation for each of the plurality of communication terminals.

According to an embodiment of the present application, when a participant participates in a certain event using multiple communication terminals, the participant makes a start request for one of the multiple communication terminals, to cause one or more other communication terminals to participate in the certain event.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), a system of a chip (SOC), a graphics processing unit (GPU), and conventional circuit components arranged to perform the recited functions.

Each of the tables of the above-described embodiments may be generated by learning effect of machine learning. In addition, in alternative to using the tables, the data of each related item may be classified by the machine learning. In the present disclosure, the machine learning is defined as a technology that makes a computer to acquire human-like learning ability. In addition, the machine learning refers to a technology in which a computer autonomously generates an algorithm required for determination such as data identification from learning data loaded in advance and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning.

Although the event management system, the event management apparatus, the method for managing an event, and the program according to embodiments of the present disclosure have been described above, the above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An event management system comprising:
multiple communication terminals used in an event; and
an event management apparatus including first circuitry, wherein
the first circuitry of the event management apparatus is configured to:
receive an event start request that requests start of the event, the event start request being transmitted by one communication terminal among the multiple communication terminals; and
in response to the received event start request, transmit an event participation request that requests participation in the event to another communication terminal among the multiple communication terminals, said another communication terminal being associated with the event and associated with a participant who participates in the event using the one communication terminal.

2. The event management system of claim 1, wherein
the first circuitry of the event management apparatus receives the event start request that is generated in response to an operation for participating in the event, the operation being performed at the one communication terminal.

3. The event management system of claim 1, wherein
the first circuitry of the event management apparatus transmits an event start response to the received event start request to the one communication terminal.

4. The event management system of claim 1, wherein
the first circuitry of the event management apparatus transmits the event participation request to said another communication terminal that is used together with the one communication terminal in a resource in which the event is conducted.

5. The event management system of claim 1, wherein
said another communication terminal includes second circuitry configured to:
receive the event participation request transmitted by the event management apparatus; and
execute a process of participating in the event in response to the received event participation request.

6. The event management system of claim 1, wherein
said another communication terminal is associated with event identification information identifying the event.

7. The event management system of claim 1, wherein
said another communication terminal is associated with participant identification information identifying a participant who participates in the event.

8. The event management system of claim 1, wherein
said another communication terminal includes a shared terminal used in a resource in which the event is conducted.

9. The event management system of claim 1, wherein
the one communication terminal includes third circuitry configured to cause a display to display a graphical representation for setting the one communication terminal and said another communication terminal in association with each other.

10. The event management system of claim 9, wherein
the third circuitry of the one communication terminal causes the display to display information indicating said another communication terminal and a shared terminal, which are used in the event.

11. The event management system of claim 9, wherein
the third circuitry of the one communication terminal causes the display to display a graphical representation for inquiring the participant whether to accept a combination that is set by associating the one communication terminal with said another communication terminal to participate in the event.

12. An event management apparatus that manages one communication terminal among multiple communication terminals used in an event in association with the event, the event management apparatus comprising circuitry configured to:
receive an event start request that requests start of the event, the event start request being transmitted by the one communication terminal; and
in response to the received event start request, transmit an event participation request that requests participation in the event to another communication terminal among the multiple communication terminals, said another communication terminal being associated with the event and associated with a participant who participates in the event using the one communication terminal.

13. An event management method performed by an event management apparatus that manages one communication terminal among multiple communication terminals used in an event in association with the event, the method comprising:
receiving an event start request that requests start of the event, the event start request being transmitted by the one communication terminal; and
in response to receiving the event start request, transmitting an event participation request that requests participation in the event to another communication terminal among the multiple communication terminals, said another communication terminal being associated with the event and associated with a participant who participates in the event using the one communication terminal.
